(19) United States
(12) Patent Application Publication
(10) Pub. No.: US 2011/0020536 A1
(43) Pub. Date: Jan. 27, 2011

(54) ELECTRODE FOR LITHIUM SECONDARY BATTERY AND METHOD OF MANUFACTURING SAME

(76) Inventors: Taisuke Yamamoto, Nara (JP); Kazuyoshi Honda, Osaka (JP); Hideharu Takezawa, Nara (JP)

Correspondence Address: MCDERMOTT WILL & EMERY LLP, 600 13TH STREET, NW, WASHINGTON, DC, 20005-3096, US

(21) Appl. No.: 12/934,200

(22) PCT Filed: Mar. 26, 2009
(86) PCT No.: PCT/JP2009/001352

§ 371 Date: Sep. 23, 2010

(30) Foreign Application Priority Data
Mar. 26, 2008 (JP) 2008-079612
Aug. 28, 2008 (JP) 2008-219649

(51) Int. Cl. B05D 5/12; H01M 4/02; H01M 4/04

(52) U.S. Cl. 427/126.3; 429/209

(57) ABSTRACT

A production method of an electrode for a lithium-ion secondary battery includes: (A) a step of providing a current collector 11 having a plurality of bumps 12 on a surface thereof; (B) a step of allowing an evaporated source material to strike from a direction E which is tilted with respect to the normal of the surface of the current collector 11 to form a corresponding plurality of pillar-like members 14 on the plurality of bumps 12; and (C) a step of oxidizing the plurality of pillar-like members 14 to form a plurality of active material members 18 containing an oxide of the source material.

### TECHNICAL FIELD

The present invention relates to an electrode for a lithium secondary battery and a production method thereof.

### BACKGROUND ART

In recent years, with the development of portable devices such as personal computers and mobile phones, there is an increasing need for batteries as their power supplies. Batteries to be used for such purposes are required to have a high energy density. Against such requirements, lithium secondary batteries are drawing attention, and active materials which have a higher capacity than conventionally are being developed for either their positive electrodes or their negative electrodes. Among others, an elemental, oxide, or alloy form of silicon (Si) or tin (Sn) is regarded as a promising active material which can provide a very large capacity.

However, when an electrode for a lithium secondary battery is constructed by using such active materials, there is a problem in that the electrode will be deformed through repetitive charging and discharging. The aforementioned active materials undergo significant volumetric changes when reacting with lithium ions. Therefore, at the time of charging and discharging, the active material will undergo significant expansion/contraction due to reactions of insertion and desorption of lithium ions with respect to the active material. Therefore, when charging and discharging are repeated, a large stress will occur in the electrode to cause strain, thus resulting in wrinkles, breaks, and the like. Moreover, when the electrode is strained and deformed, a space may be created between the electrode and the separator, so that the charging and discharging reaction may become nonuniform, thus locally deteriorating the battery characteristics. Therefore, it has been difficult to obtain a lithium secondary battery having sufficient charge-discharge cycle characteristics by using the aforementioned active material.

In order to solve these problems, Patent Document 1 proposes forming an active material layer composed of a plurality of pillar-like active material members via oblique vapor deposition. This allows voids to be provided between adjoining active material members, whereby the stress due to expansion of the active material can be alleviated.

Patent Document 2 proposes providing a ruggedness pattern on a current collector, and forming an active material member on each bump of the ruggedness pattern via oblique vapor deposition. This allows voids to be formed between adjoining active material members with greater certainty, so that the stress due to expansion of the active material can be alleviated more effectively. As a result, electrode deformation due to expansion stress can be suppressed.

Now, the reason why a plurality of active material members are formed via oblique vapor deposition will be described. When a vapor-deposition material is allowed to obliquely strike a current collector having ruggednesses on its surface, each bump on the current collector surface forms a region which is shaded and not bombarded with a vapor-deposition material. Therefore, when an oblique vapor deposition is performed, the vapor-deposition material is likely to be deposited on each bump of the current collector, and an active material member will grow in a pillar shape on each bump. When the active material members grow, the active material members themselves cast shadows on the current collector; therefore, on the current collector surface, regions are created which are shaded by the bumps and by the active material members growing in pillar shapes, such that the vapor-deposition material is not deposited there (shadowing effect). As a result, an active material layer is obtained which is structured so that a plurality of active material members are disposed at intervals. Note that the intervals between active material members can be adjusted based on the evaporation direction, the size of the surface ruggednesses of the current collector, and the like.

Moreover, in the electrode production methods described in Patent Document 1 and Patent Document 2, active material members of silicon oxide (SiOx, 0<x<2) are formed via reactive evaporation. Generally speaking, as its oxygen ratio (the aforementioned x) decreases, an active material containing silicon will have a higher charge-discharge capacity, but a greater coefficient of volumetric expansion due to charging. The reason is that, in order to suppress deteriorations in the charge-discharge cycle characteristics, it is preferable to use silicon oxide as opposed to elemental silicon. Therefore, the oxygen ratio x of silicon oxide should be selected as appropriate, by considering the balance between charge-discharge cycle characteristics and charge-discharge characteristics.

[Patent Document 1] pamphlet of International Publication No. 2007-015419

[Patent Document 2] pamphlet of International Publication No. 2007-094311

### DISCLOSURE OF INVENTION

### Problems to be Solved by the Invention

As described above, by using oblique vapor deposition, an active material (e.g., silicon oxide) can be selectively grown on each bump of the current collector by utilizing the shadowing effect, and thus pillar-like active material members can be formed on the bumps.

However, even when oblique vapor deposition is used, there is a possibility that some active material may be deposited on the portions (dents) of the surface of the current collector where bumps are not formed. The reason thereof will be described later. When the amount of active material that is deposited on the dents increases, it may become impossible to obtain sufficient voids between active material members. Moreover, wrinkles and breaks may easily occur on the current collector due to expansion stress of the active material that has been deposited on the dents. Furthermore, the active material will be likely to peel due to deformation (elongation) of the current collector. This leads to a possibility that the charge-discharge cycle characteristics may be deteriorated.

The present invention has been made in view of the above circumstances, and an objective thereof is to, while securing a charge-discharge capacity, enhance the charge-discharge cycle characteristics by providing sufficient voids between adjoining active material members.

### Means for Solving the Problems

A production method of an electrode for a lithium-ion secondary battery according to the present invention comprises: (A) a step of providing a current collector having a plurality of bumps on a surface thereof; (B) a step of allowing an evaporated source material to strike from a direction which is tilted with respect to a normal of the surface of the current collector to form a corresponding plurality of pillar-like members on the plurality of bumps; and (C) a step of oxidizing the plurality of pillar-like members to form a plurality of active material members containing an oxide of the source material.

In a preferred embodiment, step (C) comprises a step of subjecting the current collector having the plurality of pillar-like members formed thereon to a heat treatment in an oxidation ambient.

In a preferred embodiment, the current collector contains a metal as a main component; step (B) is a step of depositing the evaporated vapor deposition material on the surface of the current collector so that the surface of the current collector is partially exposed between adjoining pillar-like members among the plurality of pillar-like members; and step (C) comprises a step of oxidizing the exposed surface of the current collector to form a resistor layer having a higher resistivity than that of a material of the current collector.

Preferably, step (B) is performed in a chamber having a pressure of 0.1 Pa or less.

Preferably, the source material contains silicon, and the active material members contain silicon oxide.

An average value of a molar ratio x of an oxygen amount relative to a silicon amount of the active material members may be greater than 0.5 and less than 1.5.

In a preferred embodiment, the current collector contains copper, and the resistor layer is composed of an oxide containing copper.

A temperature of the heat treatment may be no less than 100° C. and no more than 600° C.

Another production method of an electrode for a lithium-ion secondary battery according to the present invention comprises: (a) a step of forming a plurality of pillar-like members at intervals on a surface of a current collector containing a metal as a main component, and partially exposing the surface of the current collector at the intervals between the plurality of pillar-like members; and (b) a step of subjecting the current collector having the plurality of pillar-like members formed thereon to a heat treatment in an oxidation ambient to oxidize the plurality of pillar-like members and form a plurality of active material members, and oxidizing the exposed surface of the current collector to form a resistor layer having a higher resistivity than that of a material of the current collector.

Still another production method of an electrode for a lithium-ion secondary battery according to the present invention comprises: (A) a step of providing a current collector having a plurality of bumps on a surface thereof; (a1) a step of allowing an evaporated source material to strike from a direction which is tilted with respect to a normal of the surface of the current collector to form a first pillar-like portion on each bump; (a2) a step of oxidizing the first pillar-like portion to form a first portion containing an oxide of the source material; (b1) a step of allowing an evaporated source material to strike from a direction which is tilted with respect to the normal of the surface of the current collector to form a second pillar-like portion on the first portion; and (b2) a step of oxidizing the second pillar-like portion to form a second portion containing an oxide of the source material, thereby forming an active material member on each bump, the active material member including the first and second portions.

An electrode for a lithium secondary battery according to the present invention is produced by any of the above methods.

Another electrode for a lithium-ion secondary battery according to the present invention comprises: a current collector having a plurality of bumps on a surface thereof; a plurality of active material members supported at intervals on the plurality of bumps; and a resistor layer disposed between adjoining active material members among the plurality of active material members, the resistor layer having a higher resistivity than that of a material of the current collector, wherein, the current collector contains a metal as a main component, and the resistor layer contains an oxide of the metal.

### EFFECTS OF THE INVENTION

In accordance with a production method of an electrode according to the present invention, after pillar-like members containing silicon are formed by vapor deposition, the pillar-like members are oxidized, thus forming active material members having a desired oxygen ratio x (molar ratio of the oxygen amount relative to the silicon amount). Therefore, there is no need to form silicon oxide having a desired oxygen ratio by supplying oxygen gas into the chamber at the time of vapor deposition. Thus, it is possible to perform vapor deposition in a chamber having a high degree of vacuum, so that the directionality of deposited positions of evaporated particles of source material on the current collector surface can be enhanced. As a result, the amount of active material that is deposited on portions (dents) of the current collector surface where bumps are not formed can be reduced. As a result, sufficient voids can be secured between active material members, and deteriorations of the charge-discharge cycle characteristics due to expansion stress of the active material can be suppressed. Moreover, peeling of the active material due to deformation (elongation) of the current collector can be suppressed. Furthermore, by controlling the oxygen ratio x of the active material members through an oxidation step, it is possible to enhance the charge-discharge cycle characteristics while ensuring a charge-discharge capacity.

In the aforementioned oxidation step, not only oxidizing the pillar-like members, but it is preferable to oxidize portions (exposed portions) of the current collector surface where the active material has not been deposited, thus forming a resistor layer. As a result, deposition of lithium on the current collector surface upon charging can be suppressed, whereby the safety of the lithium secondary battery can be enhanced.

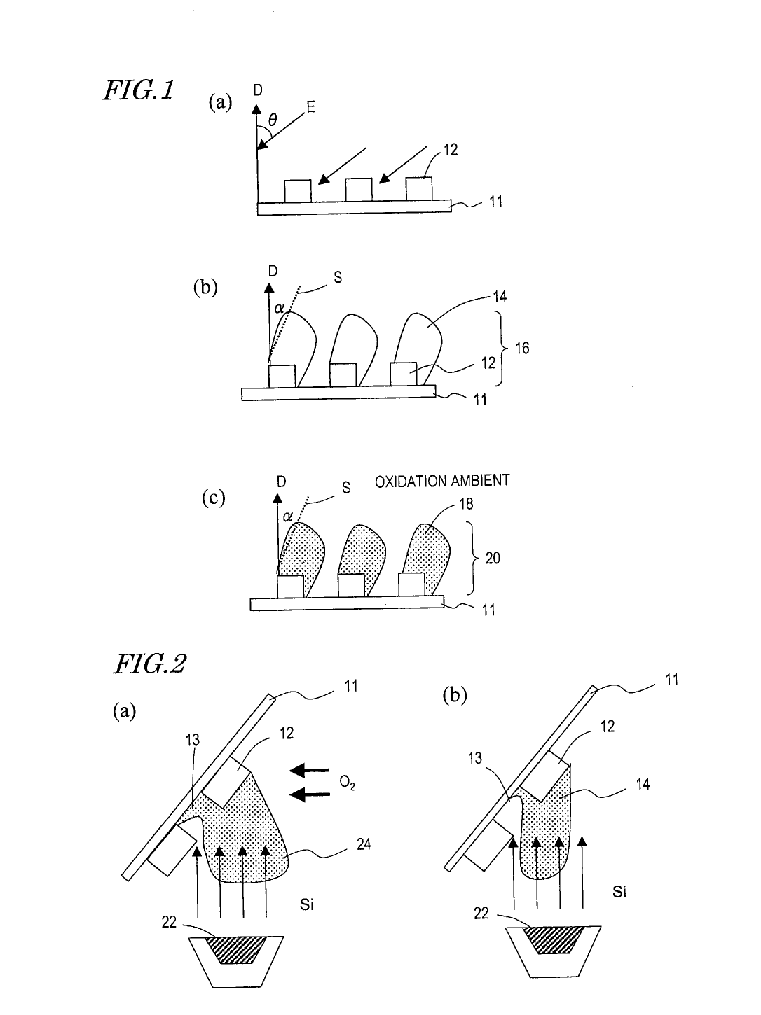

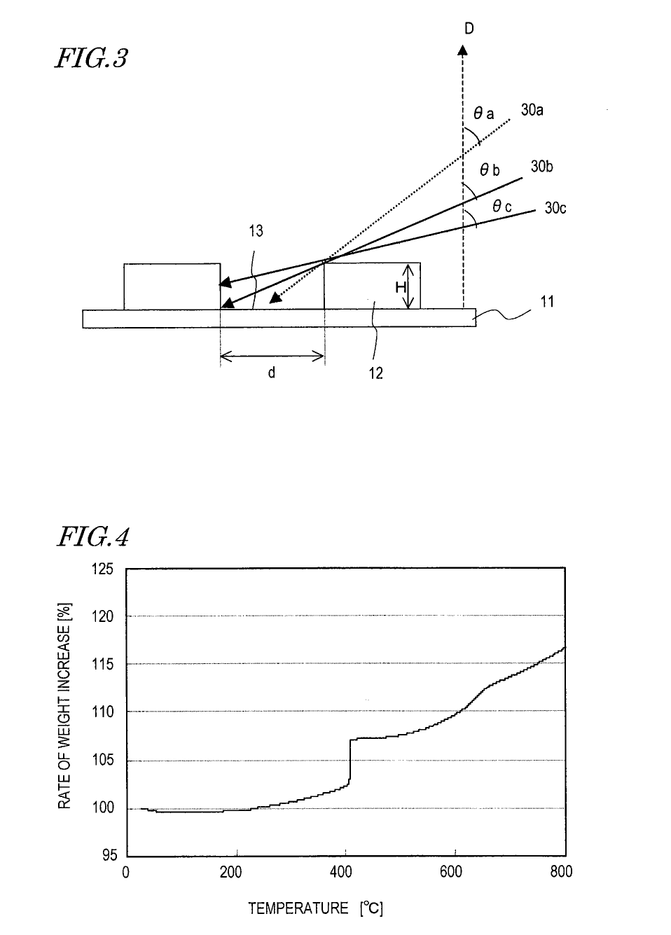

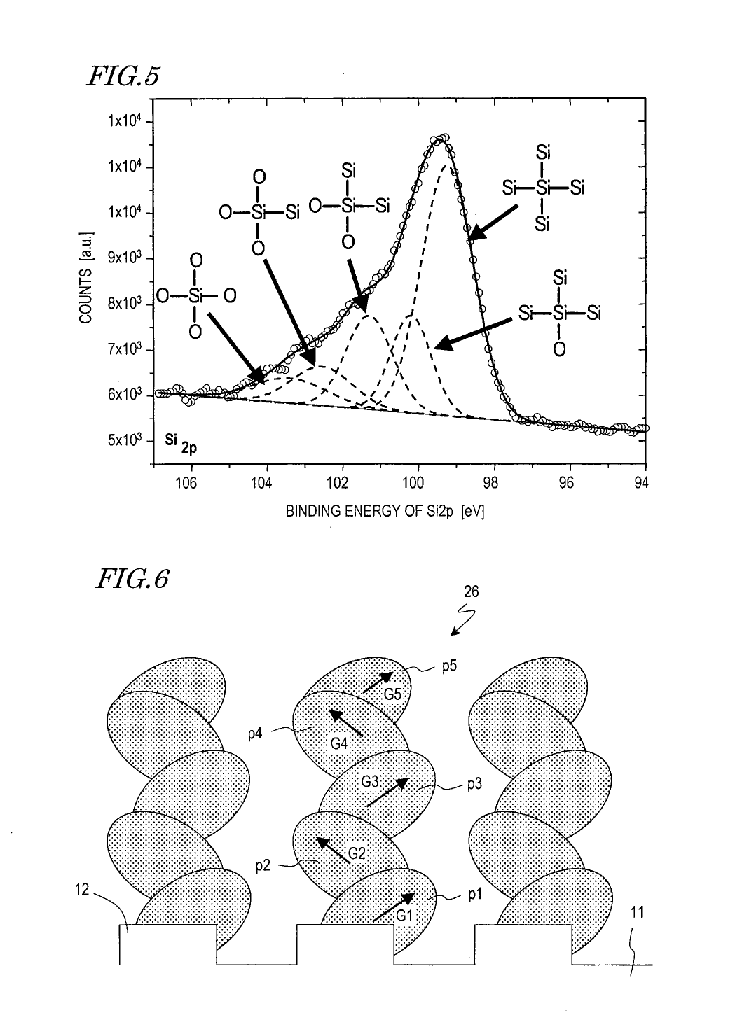

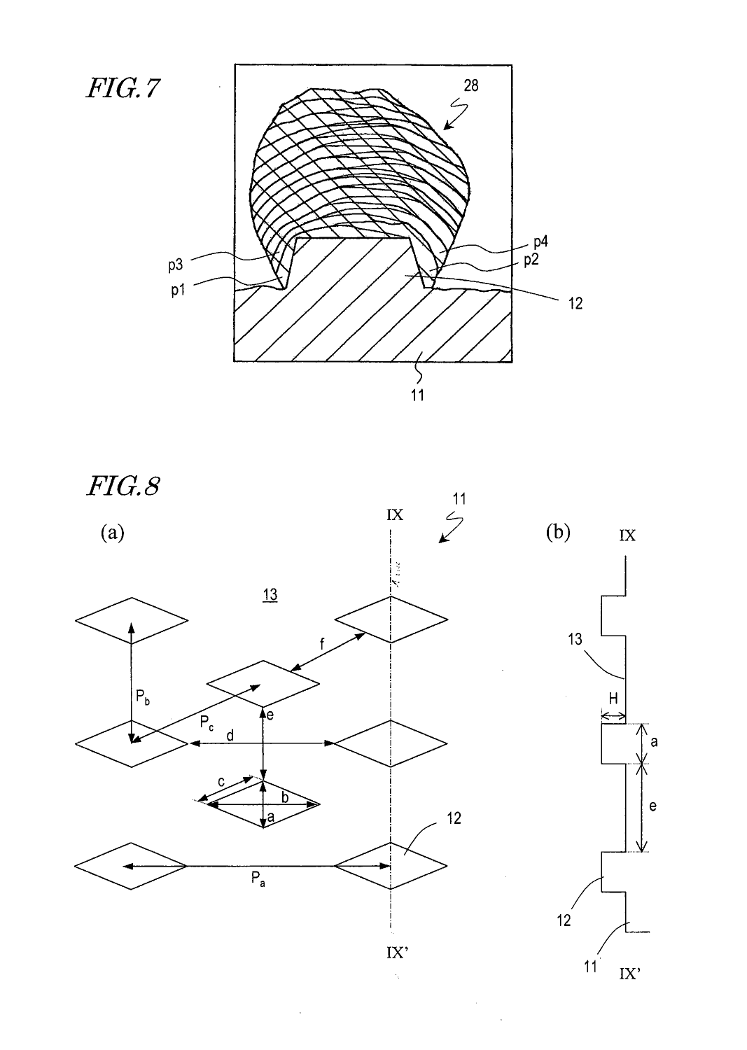

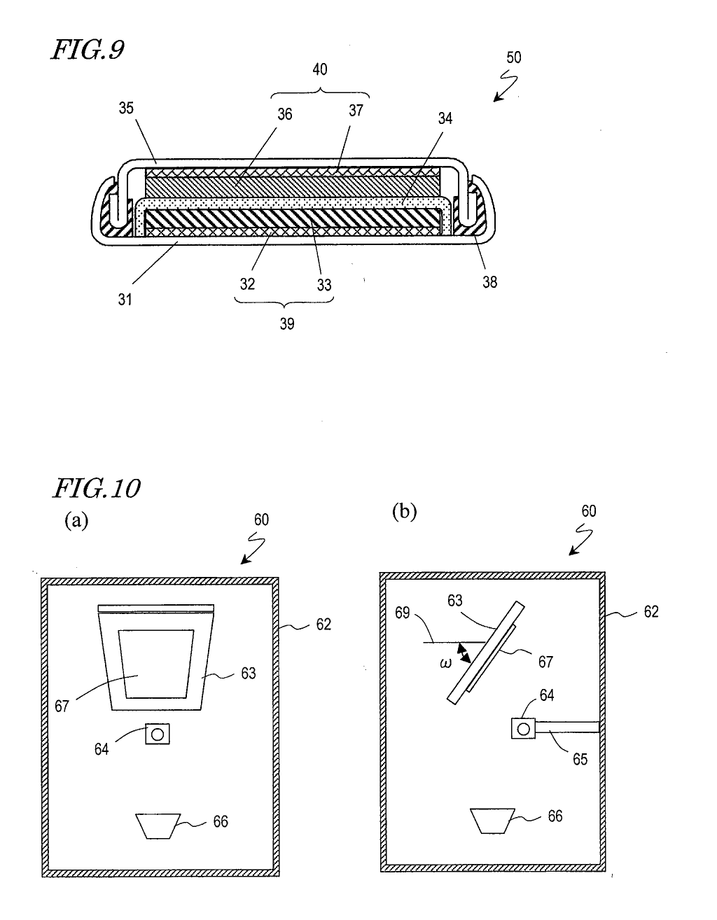

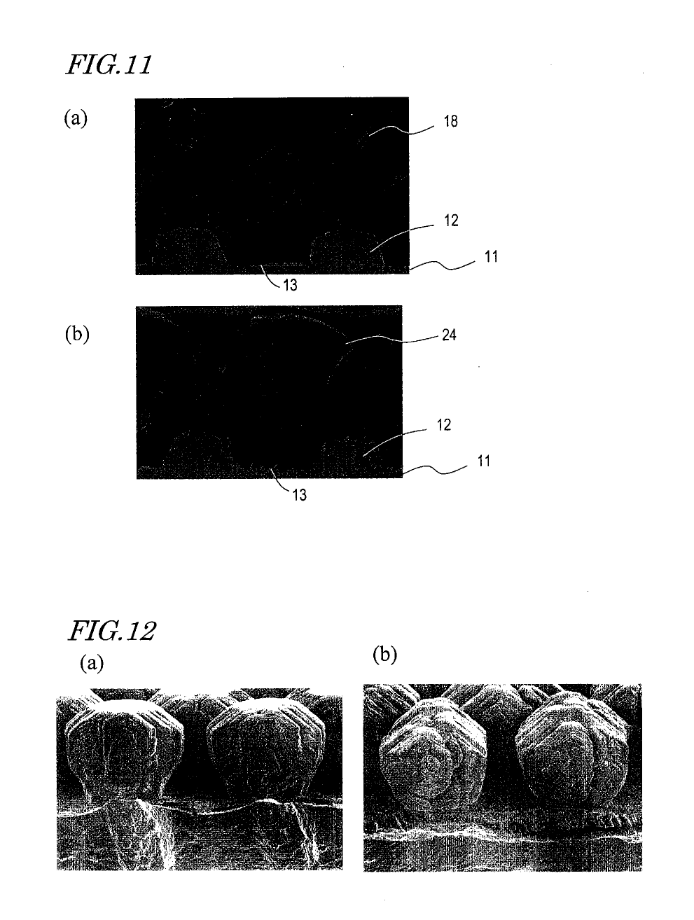

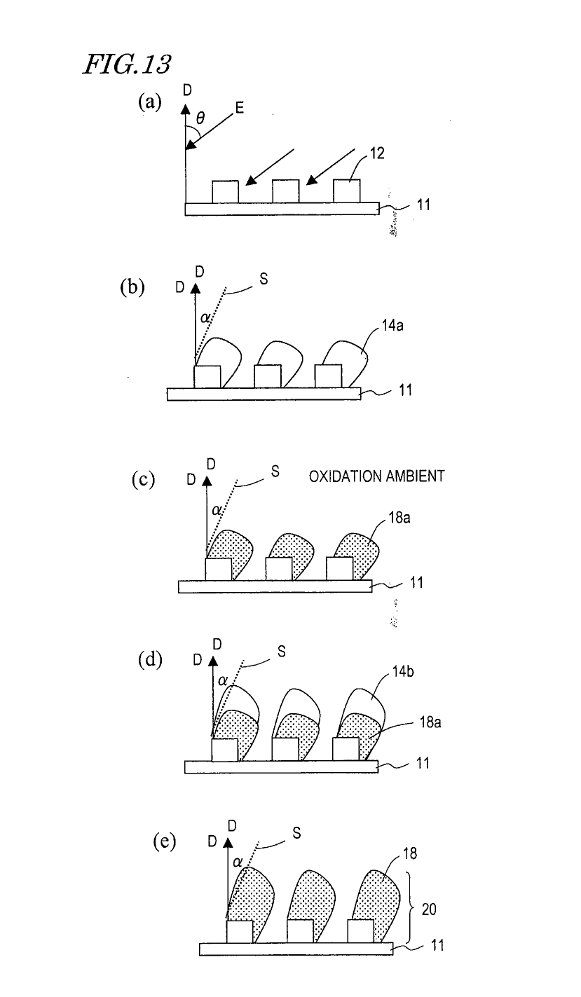

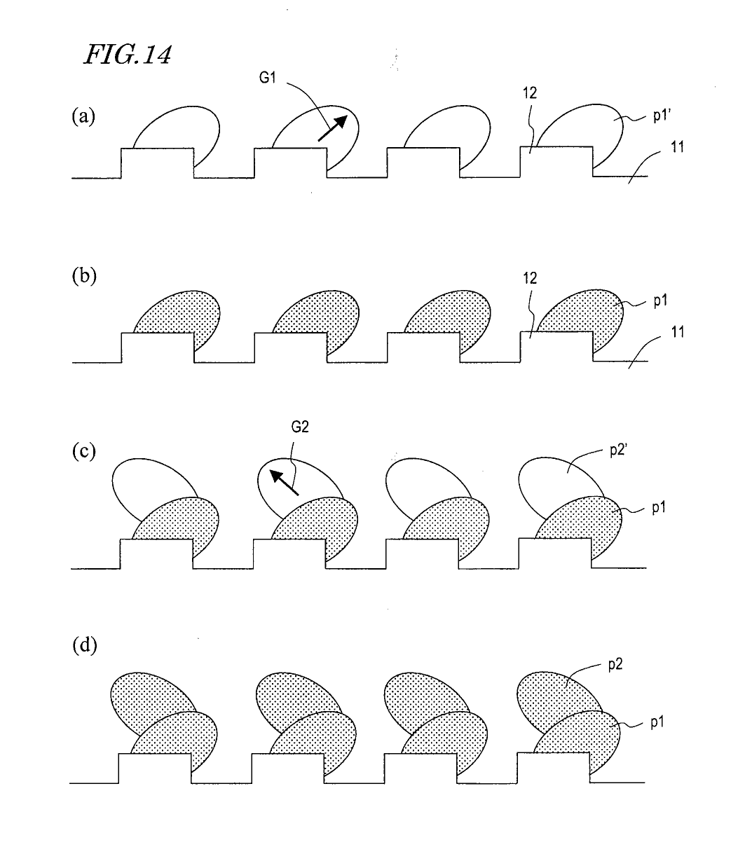

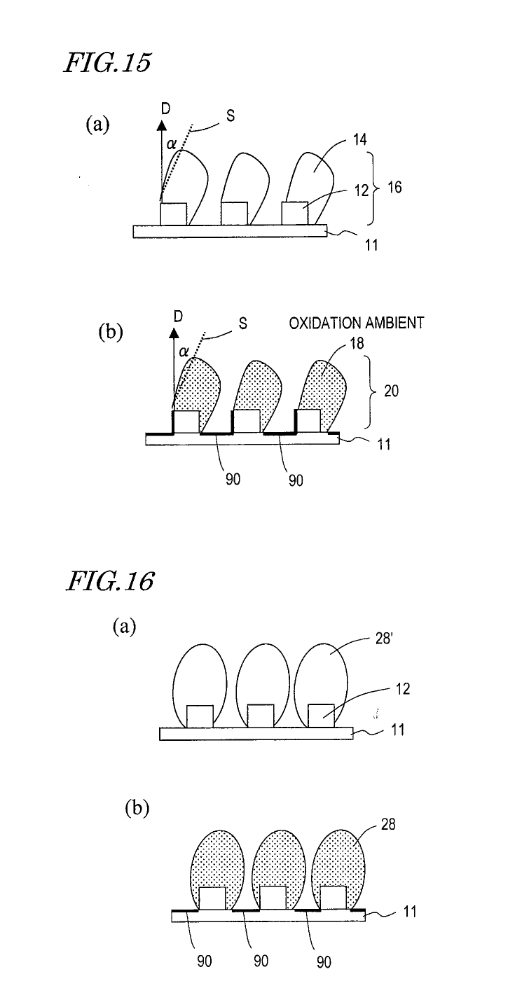

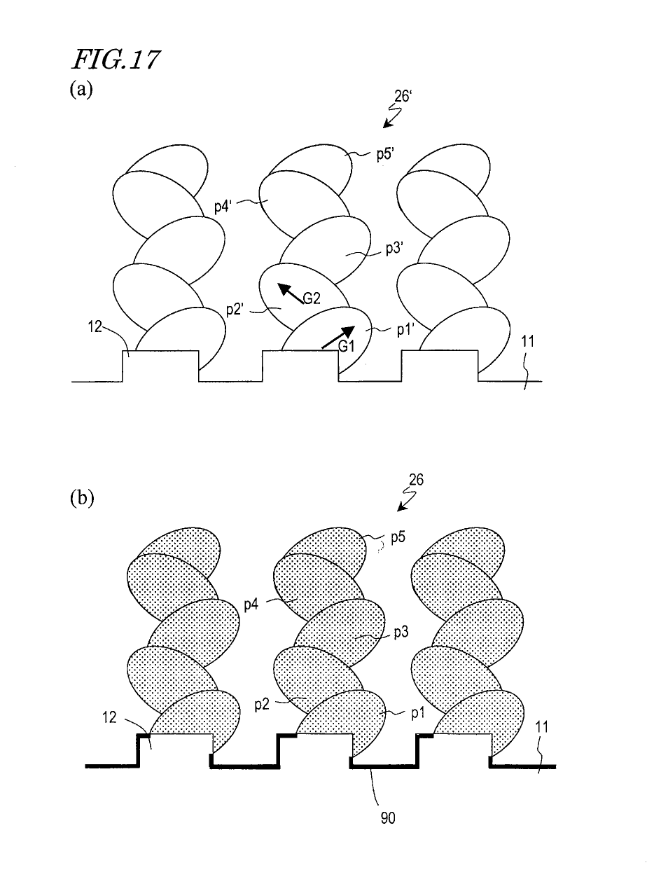

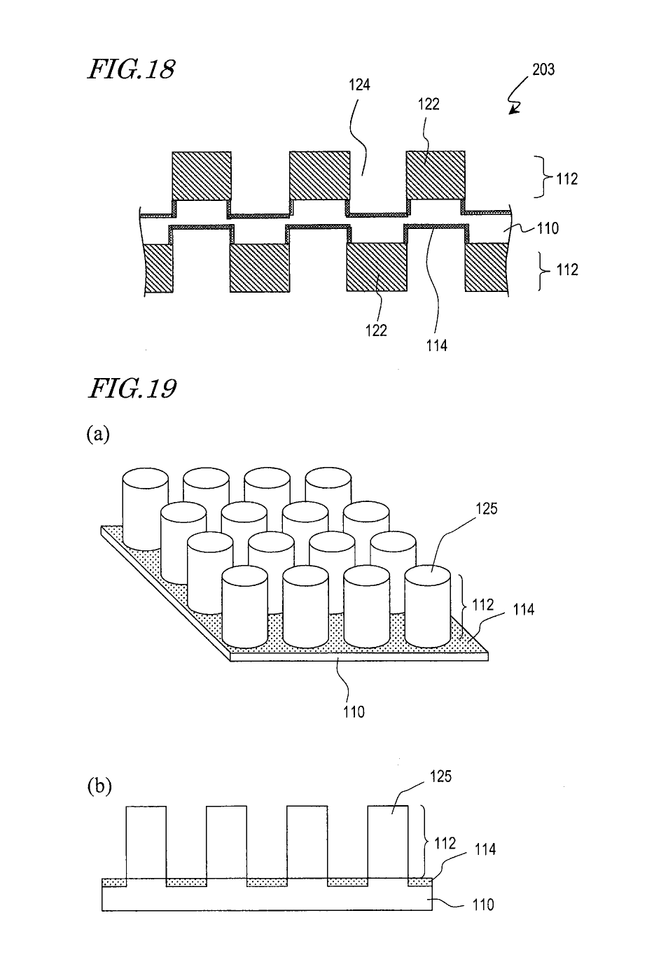

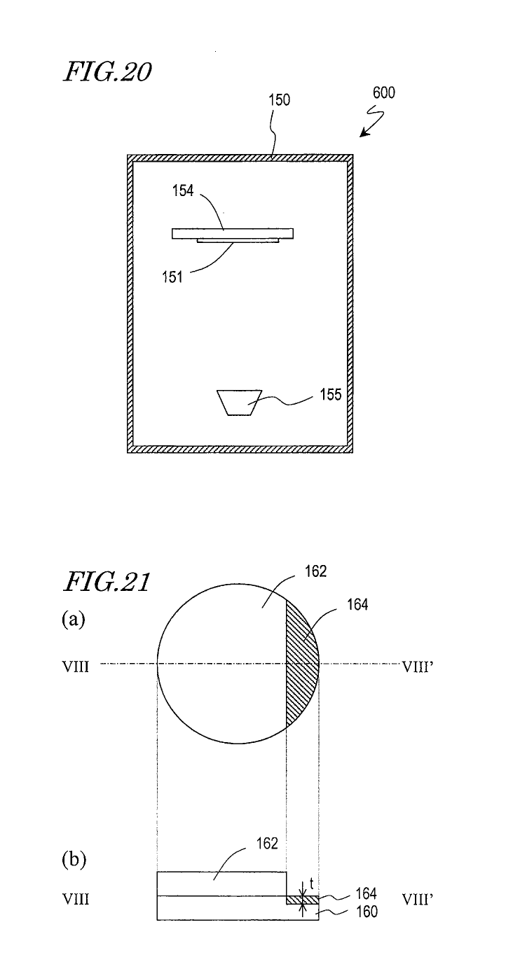

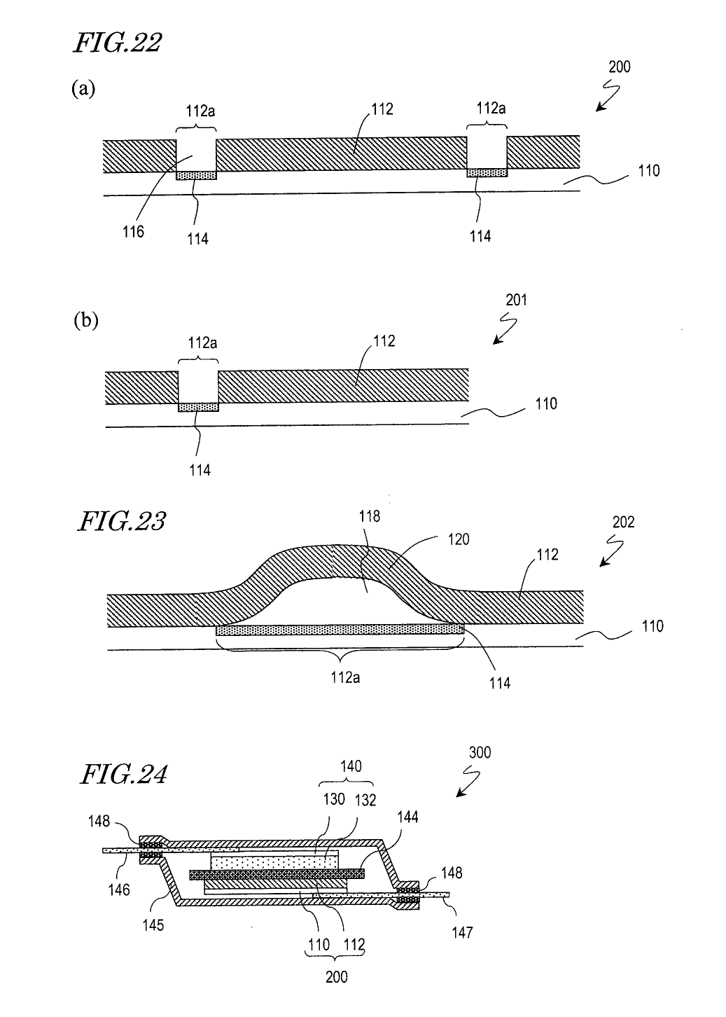

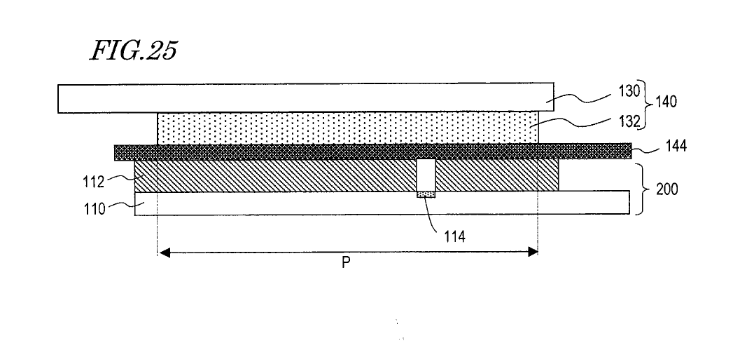

### BRIEF DESCRIPTION OF DRAWINGS

[FIG. 1] (a) to (c) are schematic cross-sectional views showing a production method of an electrode according to a first embodiment of the present invention.

[FIG. 2] (a) is a schematic enlarged cross-sectional view for describing a conventional vapor deposition step; and (b) is a schematic enlarged cross-sectional view for describing a vapor deposition step according to the first embodiment.

[FIG. 3] A schematic cross-sectional view for describing a preferable range for an incident angle θ of particles of source material which are evaporated in a vapor deposition step.

[FIG. 4] A graph showing a relationship between heating temperature and a rate of weight increase in a current collector having pillar-like members formed thereon.

[FIG. 5] A diagram showing an XPS of silicon oxide formed via reactive evaporation.

[FIG. 6] A schematic cross-sectional view showing another example of active material members according to the first embodiment.

[FIG. 7] A schematic cross-sectional view showing still another example of an active material member according to the first embodiment.

[FIG. 8] (a) and (b) are a schematic plan view and an IX-IX′ cross-sectional view, respectively, illustrating bumps on a current collector 11 according to the present embodiment.

[FIG. 9] A schematic cross-sectional view illustrating a coin-type lithium-ion secondary battery in which the electrode according to the first embodiment is used as a negative electrode.

[FIG. 10] (a) and (b) are schematic cross-sectional views of a vacuum vapor deposition apparatus used in Example and Comparative Example-1, respectively showing cross sections along planes which are orthogonal to each other.

[FIG. 11] (a) and (b) are diagrams showing cross-sectional SEM images of Electrode 1 and Electrode A, respectively.

[FIG. 12] (a) and (b) are side views of Electrode 2 and Electrode B, respectively.

[FIG. 13] (a) to (e) are schematic cross-sectional views showing a production method of an electrode according to a second embodiment of the present invention.

[FIG. 14] (a) to (d) are schematic cross-sectional views showing another example of a production method of an electrode according to the second embodiment of the present invention.

[FIG. 15] (a) and (b) are schematic cross-sectional views showing a production method of an electrode according to a third embodiment of the present invention.

[FIG. 16] (a) and (b) are schematic cross-sectional views showing another example of a production method of an electrode according to the third embodiment of the present invention.

[FIG. 17] (a) and (b) are schematic cross-sectional views showing still another example of a production method of an electrode according to the third embodiment of the present invention.

[FIG. 18] A schematic cross-sectional view showing another example of an electrode according to the third embodiment of the present invention.

[FIG. 19] (a) and (b) are a schematic perspective view and a cross-sectional view, respectively, showing still another example of an electrode according to the third embodiment of the present invention.

[FIG. 20] A schematic cross-sectional view showing a vapor deposition apparatus used for forming active material layers of Electrode 7 and Electrode D.

[FIG. 21] (a) and (b) are a plan view and a cross-sectional view for describing the structure of Electrodes 3 to 6.

[FIG. 22] (a) and (b) are schematic cross-sectional views each showing a portion of a negative electrode for a lithium secondary battery of a reference embodiment.

[FIG. 23] A schematic cross-sectional view showing a portion of another negative electrode for a lithium secondary battery of a reference embodiment.

[FIG. 24] A schematic cross-sectional view showing a lithium-ion secondary battery of a reference embodiment.

[FIG. 25] A schematic cross-sectional view showing an electrode group in a lithium-ion secondary battery of a reference embodiment.

### DESCRIPTION OF REFERENCE NUMERALS

11 current collector
12 bump
13 dent
14, 26′, 28′ pillar-like member
16 vapor-deposition layer
18, 26, 28 active material member
20 active material layer
22 evaporation source
90 resistor layer
110 current collector (negative-electrode current collector)
112 active material layer (negative-electrode active material layer)
112a region of current collector surface not in contact with active material
114 resistor layer
116 aperture
118 void
120 swollen portion
122, 125 active material member
124 space
130 positive-electrode current collector
132 positive-electrode active material layer
140 positive electrode
144 separator
145 outer case
146 positive electrode lead
147 negative electrode lead
148 resin material
151 current collector
154 stage
155 target
200, 201, 202, 203 negative electrode
300 lithium-ion secondary battery
600 vapor deposition apparatus

### BEST MODE FOR CARRYING OUT THE INVENTION

### First Embodiment

Hereinafter, with reference to the drawings, a first embodiment of an electrode for a lithium-ion secondary battery according to the present invention (hereinafter simply referred to as an “electrode”) will be described. The electrode of the present embodiment is applicable to either a negative electrode or a positive electrode of a lithium-ion secondary battery, but is preferably used as a negative electrode for a lithium-ion secondary battery.

FIGS. 1(a) to (c) are step-by-step cross-sectional views for describing an exemplary production method of an electrode of the present embodiment. Herein, a method of forming an active material layer having a plurality of active material members on the surface of a current collector will be described as an example.

First, as shown in FIG. 1(a), a current collector 11 having a plurality of bumps 12 on its surface is produced. It is preferable that the plurality of bumps 12 are regularly arrayed at intervals from one another on the surface of the current collector 11. A source material containing silicon is deposited on the surface of the current collector 11 via oblique vapor deposition. In the present embodiment, by using silicon as an evaporation source, evaporated silicon particles are allowed to strike in a direction (evaporation direction) E which is tilted from the normal D of the current collector surface by an angle (incident angle) θ.

In the present embodiment, vapor deposition is carried out in a vacuum chamber. At this time, since no oxygen gas is introduced in the chamber, vapor deposition can be performed in a chamber which has a higher degree of vacuum than in the case of performing reactive evaporation (pressure inside the chamber: e.g., 0.1 Pa or less, and more preferably 0.01 Pa or less).

At the vapor deposition step shown in FIG. 1(a), due to the aforementioned shadowing effect, silicon particles are not likely to be deposited on portions of the surface of the current collector 11 that are shaded by the bumps 12. Therefore, silicon particles are selectively deposited on the bumps 12. As a result, as shown in FIG. 1(b), a source material containing silicon is deposited in a pillar shape on each bump 12. In the present specification, pillar-like deposits 14 which are obtained through vapor deposition will be referred to as “pillar-like members”. Moreover, a film 16 including the plurality of pillar-like members 14 will be referred to as a “vapor-deposition layer”. The pillar-like members 14 grow in a direction (growth direction) S which is tilted with respect to the normal D of the current collector surface. It is empirically known that a tilt angle (growth angle) α of the growth direction S with respect to the normal D of the current collector 11 and the incident angle θ satisfy the relationship of 2 tan α=tan θ. Therefore, by controlling the incident angle θ, it is possible to control the growth direction S of the pillar-like members 14.

Moreover, since vapor deposition is performed without introducing any oxygen gas into the chamber in the present embodiment, pillar-like members 14 with a relatively low oxygen ratio are formed. A molar ratio x of the oxygen amount relative to the silicon amount in the pillar-like members 14 (hereinafter abbreviated as the “oxygen ratio”) is 0.2 or less, for example.

Thereafter, as shown in FIG. 1(c), the current collector 11 having the pillar-like members 14 formed thereon is subjected to a heat treatment in an oxidation ambient. The oxidation ambient is preferably an oxidation gas ambient, e.g., oxygen or ozone. The heat treatment temperature may be e.g. 300° C., and the heating time is 1 hour. As a result, the pillar-like members 14 are oxidized to become active material members 18 containing silicon oxide (SiOx, 0<x<2). In the present specification, the pillar-like structures 18 after having been oxidized will be referred to as “active material members”, as distinguished from the pillar-like members 14 before being oxidized (FIG. 1(b)). Moreover, the film 20 including the active material members 18 will be referred to as an “active material layer”, as distinguished from the vapor-deposition layer 16 before being oxidized (FIG. 1(b)).

In this manner, the active material layer 20 including the plurality of active material members 18 is obtained. Between adjoining active material members 18, voids for alleviating expansion stress of the active material are formed. Since each active material member 18 expands upon charging, adjoining active material members may come in contact with each other in some cases.

An average value of the molar ratio (oxygen ratio) x of the oxygen amount relative to the silicon amount in the active material members 18 is preferably greater than 0.5 and less than 1.5. In the case where the active material is an oxide such as silicon oxide, as its oxygen ratio decreases, it has a higher lithium occlusion ability and therefore a higher coefficient of volumetric expansion at charging. Conversely, as the oxygen ratio increases, the lithium occlusion ability decreases and the coefficient of volumetric expansion at charging also decreases. Therefore, by making the oxygen ratio x of the active material member greater than 0.5, expansion/contraction of the active material due to charge-discharge reactions can be suppressed. As a result of this, stress on the current collector due to expansion contraction (expansion stress) can be alleviated, thus making it possible to suppress electrode deformation and peeling of the active material layer due to expansion stress. As a result, deteriorations in the charge-discharge cycle characteristics can be suppressed. On the other hand, if the oxygen ratio x becomes too large, the coefficient of volumetric expansion of the active material can be reduced, but the charge-discharge capacity will decrease. Therefore, by keeping the oxygen ratio x to less than 1.5, the charge-discharge capacity can be guaranteed. Thus, when the oxygen ratio x is greater than 0.5 and less than 1.5, it is possible to reconcile high capacity and high reliability of the electrode.

In the present specification, an “average value of the molar ratio (oxygen ratio) x of the oxygen amount relative to the silicon amount” refers to a composition ratio excluding any lithium that is added to or occluded by the active material members 18. Moreover, the active material members 18 only need to contain silicon oxide having the aforementioned oxygen ratio, and may contain impurities such as Fe, Al, Ca, Mn, and Ti.

The method of the present embodiment makes it possible to form active material structures (pillar-like member shapes) through a vapor deposition step, and control the composition of the active material members 18 through a subsequent oxidation step. Therefore, in the vapor deposition step, it is not necessary to supply oxygen gas into the chamber to make consideration for the composition of the active material members 18. Thus, the vapor deposition can be performed with the gas pressure in the chamber being further reduced, whereby controllability of the shape of the pillar-like members can be improved. As a result, while ensuring a high charge-discharge capacity, deteriorations in the charge-discharge cycle characteristics due to the active material structures can be suppressed.

Hereinafter, the advantages of the vapor deposition step and the oxidation step of the present embodiment and preferable conditions thereof will be described.

### <Vapor Deposition Step>

First, with reference to FIG. 2, the reason why the shape controllability of the pillar-like members can be improved over conventional levels by the method of the present embodiment will be described.

Conventionally, in order to form an active material layer containing silicon oxide via oblique vapor deposition, it has been necessary to perform reactive evaporation (e.g., Patent Document 2). FIG. 2(a) is a diagram for describing a conventional vapor deposition step, and is a schematic enlarged cross-sectional view showing a single active material member. As shown in the figure, conventionally, by using silicon as an evaporation source 22, while supplying oxygen gas to the neighborhood of the surface of the current collector 11, silicon particles which are evaporated from the evaporation source 22 are allowed to strike the surface of the current collector 11. As a result, silicon particles and oxygen gas react on the surface of the current collector 11, whereby silicon oxide grows on the bumps 12 of the current collector 11 (reactive evaporation). In this manner, active material members 24 composed of silicon oxide are formed.

Thus, conventionally, in order to form silicon oxide having a predetermined composition (SiOx, e.g. 0.5<x≦1.5) via vapor deposition, it is necessary to perform vapor deposition while introducing oxygen gas into the chamber. However, with this method, the degree of vacuum within the chamber is lowered (the gas pressure within the chamber is increased) because of the presence of oxygen gas in the neighborhood of the surface of the current collector 11. Although depending on the flow rate of the oxygen gas, the gas pressure within the chamber will be higher than 0.1 Pa, for example. In the pamphlet of International Publication No. 2007-063765 by the Applicant, after setting the pressure inside the chamber at 0.005 Pa, oxygen gas is introduced into the chamber at a flow rate of 70 sccm, thus performing vapor deposition of silicon oxide. This document describes that the pressure inside the chamber at vapor deposition is 0.13 Pa. In such a chamber with a low degree of vacuum, the silicon particles have a small mean free path. In other words, there is an increased number of times that the silicon particle evaporated from the evaporation source will collide with other particles, e.g., oxygen molecules, before reaching the surface of the current collector 11. The direction in which silicon particles travel will change into various directions due to collision with other particles. As a result, the silicon particles will reach the current collector surface, and are deposited there, from a direction which is different from the direction (evaporation direction) E that is determined by the layout of the evaporation source and the current collector surface. Therefore, the directionality as to the deposited positions of silicon particles on the current collector surface is reduced.

When the directionality of the silicon particles is reduced, silicon oxide is more likely to be deposited also in regions of the surface of the current collector 11 that are shaded by the bumps 12. Moreover, the active material members 24 grow in directions which are deviated from the growth direction which is determined by the aforementioned equation 2 tan α=tan θ. As a result, the shape of the active material members 24 cannot be sufficiently controlled based on vapor deposition conditions such as the incident angle θ. Specifically, the active material is likely to grow in various directions which are different from the direction determined by the above equation, thus increasing the width (thickness) of the active material members 24.

Thus, with the conventional method, there is a fear that silicon oxide may be deposited also in regions (dents) 13 where the bumps 12 of the current collector 11 are not formed, and that the width of the active material members 24 may also increase. This leads to a possibility that sufficient voids may not be formed between adjoining active material members 24. Moreover, when the amount of silicon oxide that is deposited on the dents 13 increases, peeling of the active material becomes likely to occur due to expansion/contraction of the active material.

On the other hand, according to the present embodiment, it is not necessary to introduce oxygen gas into the chamber at vapor deposition. Alternatively, it is possible to reduce the amount of oxygen gas to be introduced. The reason is that, even if the pillar-like members obtained via vapor deposition have a low oxygen ratio x, the oxidation level of the pillar-like members can be enhanced through a subsequent oxidation step.

FIG. 2(b) is a diagram for describing a vapor deposition step according to the present embodiment, and is a schematic enlarged cross-sectional view showing a single active material member. In the present embodiment, no oxygen gas is introduced into the chamber, so that the degree of vacuum within the chamber can be enhanced over the conventional level. Therefore, the silicon particles evaporated from the evaporation source 22 have a larger mean free path, thus enhancing the directionality of the deposited positions on the surface of the current collector 11. Therefore, as shown in the figure, the amount of silicon particles that are deposited on the dents 13 of the current collector 11 can be greatly reduced from the conventional level. Moreover, the growth direction of the pillar-like members 14 is not greatly deviated from the direction determined from the above equation. Therefore, the width (thickness) of the pillar-like members 14 can be reduced from the conventional level. Although an oxidation step is performed after this vapor deposition step, the shape of the active material members 18 obtained after the oxidation step is substantially the same as the shape of the pillar-like members 14.

There is no generalization as to the directionality of the particles of source material, which may vary depending on the degree of vacuum within the chamber, the vapor deposition temperature, the distance between the current collector and the evaporation source, and the like; however, the degree of vacuum within the chamber is preferably 0.1 Pa or less, for example, and more preferably 0.01 Pa or less. In particular, in the case where vapor deposition is performed without introducing any oxygen gas into the chamber, the pressure inside the chamber can be lowered to 0.001 Pa or less, for example. As a result of this, the aforementioned effect can be obtained with greater certainty.

In the present embodiment, the tilting angle of the evaporation direction E (incident angle) θ is preferably set so that the particles of source material evaporated from the evaporation source (which herein are silicon particles) do not strike the regions (dents) 13 of the current collector 11 where the bumps 12 are not formed.

FIG. 3 is a schematic cross-sectional view for describing a preferable range for the incident angle θ according to the present embodiment. In the following description, it is assumed that the particles of source material evaporated from the evaporation source reach the surface of the current collector 11 without colliding with any other particles.

As shown in the figure, an evaporation direction when the incident angle θ, the height H of the bumps 12 of the current collector 11, and the interval d between adjoining bumps 12 satisfy the equation d=H×tan θ is designated a direction 30b; and the incident angle in this case is designated an angle θ b. When vapor deposition is performed from a direction having a smaller tilt from the normal D of the current collector 11 than does the evaporation direction 30b (e.g., an evaporation direction 30a), some particles of source material will strike and be deposited in a dent 13 of the current collector 11. On the other hand, if vapor deposition is performed from a direction which is more tilted than the evaporation direction 30b (e.g., an evaporation direction 30c), substantially the entire dent 13 is shaded by a bump 12, so that particles of source material do no strike the dent 13 because of the shadowing effect. Therefore, it is preferable that the incident angle θ is set so as to satisfy the following inequality.

d<H×tan θ (d: bump interval; H: bump height; θ: incident angle)

Note that, as described earlier, the incident angle θ is an angle which is determined by the layout of the evaporation source and the surface of the current collector 11 within the chamber.

Thus, although depending on the interval d and the height H of the bumps 12, the preferable range for the incident angle θ is 5° or more, for example, and more preferably 10° or more. This makes it easier to obtain sufficient voids between pillar-like members 14. Moreover, the incident angle θ may be less than 90°, but it becomes more difficult to form the pillar-like members 14 as it approaches 90°, and therefore it is preferably less than 80°. More preferably, it is no less than 20° and no more than 75°.

### <Oxidation Step>

In the present embodiment, the pillar-like members 14 obtained through the aforementioned vapor deposition step are oxidized. Through this, the active material members 18, which have substantially the same shape as the pillar-like members 14 and have a desired oxygen ratio x, are formed. Oxidation of the pillar-like members 14 can be carried out by heating the current collector 11 having the pillar-like members 14 formed thereon in an oxidation gas ambient, for example.

Note that Japanese Laid-Open Patent Publication No. 2004-319469, for example, discloses forming a thin surface layer (e.g., a silicon oxide layer) on an active material surface by subjecting the active material to a heat treatment, for the purpose of suppressing expansion of the active material and improving the charge-discharge cycle characteristics. On the other hand, in the present embodiment, a heat treatment is performed in order to control the composition (oxygen ratio) of the active material, and thus the heat treatment is directed to a totally different purpose. Moreover, in the above publication, since a thin film which is relatively dense in texture is subjected to a heat treatment, a surface layer will be formed on the surface of the thin film, but the oxidation level inside the thin film is difficult to be enhanced. On the other hand, in the present embodiment, the vapor-deposition layer 16 having sufficient voids is formed by utilizing the shadowing effect from the bumps 12 of the current collector 11. Therefore, the subsequent oxidation step can oxidize not only the surface of the vapor-deposition layer 16, but also an active plane within each pillar-like member 14 contained in the vapor-deposition layer 16. As a result, the oxygen ratio of not only the surface of the pillar-like members 14 but also their interior can be enhanced, whereby active material members 18 having a more uniform composition can be obtained.

In the present embodiment, as will be described below, it is possible to control the composition of the active material members 18 obtained after the oxidation, by adjusting the heat treatment conditions such as the heating temperature, the oxidation gas partial pressure in the oxidation gas ambient, and the heating time.

The inventors have produced a current collector sample having the pillar-like members 14 formed thereon, and heated it in an oxidation gas ambient (which was the atmosphere) to examine changes in the weight of the sample. The results are shown in FIG. 4. FIG. 4 is a graph showing a relationship between the heating temperature and the rate of weight increase of the sample. A greater sample weight indicates a greater oxidation level of the pillar-like members 14. In these results, as the heating temperature increases, the oxygen ratio in the pillar-like members 14 is increased. Thus, it is indicated that the oxygen ratio of the active material members 18 can be controlled by controlling the heating temperature. Although the sample weight is slightly reduced at temperatures of 100° C. or below, presumably this is because adsorbed water was desorbed from the pillar-like members and oxidation was actually in progress.

The oxidation level of the pillar-like members 14 can be enhanced with greater certainty when the heating temperature is 100° C. or more, for example, although this depends on the height of the active material members 18, the volumetric ratio which the active material members 18 account for in the entire active material layer 20, the composition of the pillar-like members 14, and the like. On the other hand, from the standpoint of the thermal resistance of the current collector 11 and the production process, the heating temperature is preferably 600° C. or less, for example. More preferably, it is no less than 200° C. and no more than 600° C.

In the graph shown in FIG. 4, the rate of weight increase has a drastic increase at a temperature of 400° C. This is because the sample was retained at the temperature of 400° C. for 10 minutes. This confirms that the oxygen ratio can also be controlled based on the heating time (the time for which the pillar-like members 14 are retained at a predetermined temperature). The heating time is preferably 60 seconds or more, for example. As a result, not only the surface of the pillar-like members 14, but also the active planes within the pillar-like members 14 are oxidized, whereby active material members 18 with a more uniform composition can be obtained. On the other hand, the producibility will deteriorate if the heating time is too long, and therefore the heating time is preferably 24 hours or less.

Although there is no particular limitation, the partial pressure of oxidation gas in the oxidation gas ambient may be 100 Pa or more, for example, in which case the pillar-like members 14 can be oxidized with greater certainty. As the oxidation gas, oxygen, ozone, or the like can be used.

The silicon oxide contained in the active material members 18 of the present embodiment differs from silicon oxide which is obtained through reactive evaporation in terms of containing a larger amount of stable tetravalent Si. FIG. 5 is an XPS of silicon oxide which is formed via reactive evaporation. An oxidation state of Si can be known by use of XPS. As shown in the figure, in silicon oxide which is obtained via reactive evaporation, Si valences from zero-valent to tetravalent are mixedly present, among which tetravalent Si accounts for a relatively low proportion. On the other hand, in silicon oxide which is obtained by being oxidized after vapor deposition as in the present embodiment, stable tetravalent Si accounts for a large proportion. Therefore, in the XPS of the silicon oxide of the present embodiment, there is more of a tetravalent Si peak (binding energy: about 103 to 104 eV) than in the XPS shown in FIG. 5.

It suffices if the active material member of the present embodiment has a growth direction S which is tilted with respect to the normal D of the current collector 11, and the shape of the active material members is not limited to the shape shown in FIG. 1(c).

FIG. 6 and FIG. 7 are schematic cross-sectional views illustrating other active material members according to the present embodiment. The active material members shown in FIG. 6 and FIG. 7 have a multilayer structure.

In the example shown in FIG. 6, each active material member 26 has a plurality of portions p1 to p5 stacked on a bump 12 of the current collector 11 (number of layers: 5). The respective growth directions G1 to G5 of the plurality of portions p1 to p5 are tilted in alternately opposite directions with respect to the normal direction of the current collector 11.

The active material members 26 are formed as follows. First, oblique vapor deposition is performed a plurality of times (which herein is five times) while switching the evaporation direction, thus forming zigzag-shaped pillar-like members on the surface of the current collector 11. Next, by a method similar to that of FIG. 1(c), the pillar-like members are oxidized, thus obtaining the active material members 26 as shown. Specific vapor deposition conditions for forming zigzag-shaped pillar-like members are described in pamphlet of International Publication No. 2007/086411 by the Applicant, for example.

In the example shown in FIG. 7, the active material member 28 has a structure in which 25 portions p1, p2, . . . are stacked (number of layers: 25). Similarly to the above, the active material member 28 is also obtained by first forming a pillar-like member by performing a plurality of times of oblique vapor deposition while switching the evaporation direction and then oxidizing the pillar-like member. In the example shown in FIG. 7, when the number of layers becomes large (e.g., 20 layers or more), a shape that stands upright on the surface of the current collector 11 may be obtained, instead of a zigzag shape.

Although a method of forming an active material layer 20 containing silicon oxide is described in FIGS. 1(a) to (c), an active material layer containing any other oxide that is capable of occluding and releasing lithium (e.g., tin oxide) may be formed. In this case, a vapor-deposition layer containing tin (Sn) is formed by oblique vapor deposition, and by oxidizing this, an active material layer containing tin oxide can be formed.

In the present embodiment, the bumps 12 are arrayed on the surface of the current collector 11, and it is possible to control the width of the voids between active material members 18 by selecting the layout (interval, arraying pitch) and size (width, height, etc.) of the bumps 12 as appropriate.

Hereinafter, with reference to the drawings, preferable layouts and sizes of the bumps 12 of the present embodiment will be described.

FIG. 8(a) and FIG. 8(b) are a schematic plan view and an IX-IX′ cross-sectional view, respectively, illustrating the bumps 12 of the current collector 11 according to the present embodiment.

In the illustrated example, the bumps 12 are pillar-like members having diamond-shape upper faces, but the shape of the bumps 12 is not limited thereto. An orthogonal projection image of a bump 12 as seen from the normal direction D of the current collector 11 may be a polygon such as a square, a rectangle, a trapezoid, a diamond shape, a parallelogram, a pentagon or a home-plate shape, a circle, an ellipse, or the like. The shape of its cross section which is parallel to the normal direction D of the current collector 11 may be a square, a rectangle, a polygon, a semicircular shape, or a shape which is a combination thereof. Moreover, the shape of a bump 12 in a cross section perpendicular to the surface of the current collector 11 may be a polygon, a semicircular shape, an arc shape, or the like, for example. Note that, in the case where the boundaries between the bumps 12 and portions other than the bumps (also referred to as “grooves”, “dents”, etc.) are not clear, e.g., the cross section of the ruggedness pattern formed on the current collector 11 having a shape which is composed of curves, any portion of the entire surface having a ruggedness pattern that has an average height or more will be defined as a “bump 12”, whereas any portion that has less than the average height will be defined as a “groove” or a “dent”. A “dent” may be a single continuous region as in the illustrated example, or may be a plurality of regions which are separated from one another by the bumps 12. Furthermore, the “interval between adjoining bumps 12” as used in the present specification means a distance between adjoining bumps 12 on a plane which is parallel to the current collector 11, referring to “the width of a groove” or “the width of a dent”.

Moreover, in a plan view of the current collector 11 (FIG. 8(a)), the proportion which the total area A1 of the plurality of bumps 12 accounts for in a sum of the total area A1 of the plurality of bumps 12 and the total area A2 of the dents is preferably no less than 10% and no more than 30% (0.1≦{A1/(A1+A2)}0.3). Stated otherwise, as seen from the normal direction of the surface of the current collector 11, the proportion which the total area A1 of the plurality of bumps 12 accounts for in the area of the surface of the current collector 11 is no less than 10% and no more than 30%. As used herein, the “area of the surface of the current collector 11” means the area of a region of the surface of the current collector 11 where the active material layer 20 is formed, as seen from the normal direction of the surface of the current collector 11, and does not include any region which lacks the active material layer 20 and which is used as a terminal, for example.

If the above proportion is less than 10%, the possibility that the active material members 18 will be formed in regions other than the bumps 12 will increase, so that sufficient spaces cannot be obtained between adjoining active material members 18. As a result, expansion of the active material members 18 upon charging may not be sufficiently alleviated, and deformation of the electrode plate may occur. On the other hand, if the above proportion exceeds 30%, spaces between adjoining active material members 18 will become insufficient, and thus sufficient spaces for alleviating the expansion of the active material members 18 may not be obtained. On the other hand, by controlling the aforementioned proportion to no less than 10% and no more than 30% as described above, spaces for expansion of the active material members 18 can be secured between adjoining active material members 18 with greater certainty, utilizing the shadowing effect.

The height H of a bump 12 is preferably 3 μm or more, more preferably 4 μm or more, and still more preferably 5 μm or more. If the height H is 3 μm or more, when forming active material members 12 through oblique vapor deposition, it is possible to selectively dispose the active material members 18 on the bumps 12 by utilizing the shadowing effect, so that voids can be secured between active material members 18. On the other hand, the height H of the bumps 12 is preferably 15 μm or less, and more preferably 12 μm or less. If the bumps 12 are 15 μm or less, the volumetric ratio which the current collector 11 accounts for in the electrode can be kept small, whereby a high energy density can be obtained.

Preferably, the bumps 12 are regularly arrayed with a predetermined arraying pitch, and may be arrayed in a pattern such as a houndstooth check or a grid. The arraying pitch of the bumps 12 (distance between the centers of adjoining bumps 12) is no less than 10 μm and no more than 100 μm, for example. As used herein, the “center of a bump 12” means a center point across the largest width of the upper face of the bump 12. If the arraying pitch is 10 μm or more, spaces for the active material members 18 to expand can be secured between adjoining active material members 18 with greater certainty. It is preferably 20 μm or more, and more preferably 30 μm or more. On the other hand, if the arraying pitch P is 100 μm or less, a high capacity can be obtained without increasing the height of the active material members 18. It is preferably 80 μm or less, more preferably 60 μm or less, and still more preferably 50 μm or less. In the illustrated example, the bumps 12 are arrayed along three directions, and it is preferable that the arraying pitches Pₐ, P_{b}, and P_{c} along the respective directions are all within the aforementioned range.

Moreover, the proportion of the interval d of the bumps 12 relative to the arraying pitch Pₐ of the bumps 12 is preferably no less than 1/3 and no more than 2/3. Similarly, the proportion of the intervals e and f of the bumps 12 relative to the arraying pitches P_{b} and P_{c} of the bumps 12 is preferably no less than 1/3 and no more than 2/3. When the proportions of the intervals d, e, and f are 1/3 or more, width of the voids between active material members 18 along the respective arraying directions of the bumps 12 can be secured with greater certainty when the active material members 18 are respectively formed on the bumps 12, so that a sufficient linear voidage is attained. On the other hand, if the proportions of the intervals d, e, and f are greater than 2/3, the active material will be vapor-deposited also in the grooves between bumps 12, so that expansion stress acting on the current collector 11 may increase.

The width of the upper face of a bump 12 is preferably 200 μm or less, more preferably 50 μm or less, and still more preferably 20 μm or less. As a result, it becomes possible to ensure sufficient voids between active material members 18 by utilizing the shadowing effect, so that deformation of the electrode 100 due to expansion stress of the active material can be more effectively suppressed. On the other hand, if the width of the upper face of a bump 12 is too small, a sufficient area of contact between the active material member 18 and the current collector 11 may not be obtained; therefore, the width of the upper face of a bump 12 is preferably 1 μm or more. Particularly in the case where the bumps 12 are pillar-shaped, if the width of their upper faces is small (e.g. less than 2 μm), the bumps 12 will be thin, so that the bumps 12 will be likely to be deformed due to stress associated with charging and discharging. Therefore, the width of the upper face of a bump 12 is more preferably 2 μm or more, and still more preferably 10 μm or more, whereby deformation of the bumps 12 due to charging and discharging can be suppressed with greater certainty. In the illustrated example, it is preferable that the widths a, b, and c of the upper face of a bump 12 along the respective arraying directions are all within the aforementioned range.

Furthermore, in the case where the bumps 12 are pillar-like members having side faces which are perpendicular to the surface of the current collector 11, the intervals d, e, and f between adjoining bumps 12 are preferably 30% or more, and more preferably 50% or more, of the widths a, b, and c, respectively, of the bumps 12. As a result, sufficient voids can are obtained between active material members 18 to greatly alleviate the expansion stress. On the other hand, if the distance between adjoining bumps 12 is too large, the thickness of the active material layer 14 will be increased in order to ensure a capacity; therefore, the intervals d, e, and f are preferably 250% or less, and more preferably 200% or less, of the widths a, b, and c, respectively, of the bumps 12.

The upper face of each bump 12 may be flat, but preferably has ruggednesses, preferably with a surface roughness Ra of 0.1 μm or more. As used herein, “surface roughness Ra” refers to “arithmetic mean roughness Ra” as defined under the Japanese Industrial Standards (JISB 0601-1994), and can be measured by using a surface roughness measurement system or the like, for example. When the surface roughness Ra of the upper face of each bump 12 is less than 0.1 μm, if a plurality of active material members 18 are formed on the upper face of one bump 12, for example, the width (pillar diameter) of each active material member 18 will be small, so that they are likely to be destroyed during charging and discharging. It is more preferably 0.3 μm or more, thus making it easy for the pillar-like members 14 to grow on the bumps 12, whereby sufficient voids can be surely formed between active material members 18. On the other hand, if the surface roughness Ra is too large (e.g. over 100 μm), the current collector 11 will become thick and a high energy density will not be obtained; therefore, the surface roughness Ra is preferable 30 μm or less, for example. It is more preferably 10 μm or less, and still more preferably 5.0 μm or less. In particular, if the surface roughness Ra of the current collector 11 is within the range of no less than 0.3 μm and no more than 5.0 μm, a sufficient adhesion force can be secured between the current collector 11 and the active material members 18, whereby peeling of the active material members 18 can be prevented.

The material of the current collector 11 is preferably copper or a copper alloy which is fabricated by a rolling technique, an electrolytic technique, or the like, for example, and more preferably a copper alloy having a relatively large strength. The current collector 11 in the present embodiment can be obtained by forming a regular ruggedness pattern including the plurality of bumps 12 on the surface of a metal foil, e.g., copper, copper alloy, titanium, nickel, or stainless steel, although there is no particular limitation. As the metal foil, a metal foil such as a rolled copper foil, a rolled copper alloy foil, an electrolytic copper foil, an electrolytic copper alloy foil, or the like is suitably used, for example.

For example, the thickness of the metal foil before the ruggedness pattern is formed thereon is preferably no less than 1 μm and no more than 50 μm, although there is no particular limitation. Volumetric efficiency can be ensured at 50 μm or lower, and handling of the current collector 11 is facilitated at 1 μm or above. The thickness of the metal foil is more preferably no less than 6 μm and no more than 40 μm, and still more preferably no less than 8 μm and no more than 33 μm.

Although there is no particular limitation as to the method of forming the bumps 12, a metal foil may be subjected to an etching utilizing a resist resin or the like, thereby forming a predetermined pattern of grooves on the metal foil, such that any portion where a groove is not formed defines a bump 12, for example. Moreover, a resist pattern may be formed on a metal foil, and bumps 12 may be formed in the groove portions of the resist pattern by an electrodeposition or plating technique. Alternatively, a method may be employed which, by using a rolling roller having grooves formed thereon by pattern engraving, mechanically transfers the grooves on the rolling roller to the surface of a metal foil.

The thickness of the active material layer 20 is equal to the height of the active material members 18, and refers to the distance from the upper face of each bump 12 of the current collector 11 to the apex of the active material member 18 along the normal direction of the current collector 11, e.g. 0.01 μm or more, preferably 0.1 μm or more. As a result, a sufficient energy density is ensured, thus making it possible to take advantage of the high capacity characteristics of the active material containing silicon. Moreover, if the thickness of the active material layer 20 is 3 μm or more, for example, the volumetric ratio which the active material accounts for in the entire electrode is more increased, whereby an even higher energy density is obtained. It is more preferably 5 μm or more, and still more preferably 8 μm or more. On the other hand, the thickness of the active material layer 20 is e.g. 100 μm or less, preferably 50 μm or less, and more preferably 40 μm or less. As a result, the expansion stress due to the active material layer 20 can be suppressed, and the collector resistance can be lowered, which is advantageous for high-rate charging and discharging. If the thickness of the active material layer 20 is e.g. 30 μm or less, and more preferably 25 μm or less, deformation of the current collector 11 due to expansion stress can be suppressed more effectively. Furthermore, through the oxidation step, the oxygen ratio x can be enhanced more uniformly, across the thickness direction of the active material layer 20.

Although there is no particular limitation, in order to prevent cracks from occurring in the active material members 18 due to expansion at the time of charging, the thickness (width) of the active material members 18 is preferably 100 μm or less, and more preferably 50 μm or less. Moreover, in order to prevent the active material members 18 from peeling from the current collector 11, the width of the active material members 18 is preferably 1 μm or more. The thickness of the active material members 18 is determined from an average value, among two to ten arbitrary active material members 18, for example, of the width of a cross section which is parallel to the surface of the current collector 11 and which is along a face that is at ½ of the height of the active material members 18. If the aforementioned cross section is substantially circular, it will be an average value of the diameter.

Next, the construction of a lithium-ion secondary battery in which the electrode of the present embodiment is used will be described. FIG. 9 is a schematic cross-sectional view illustrating a coin-type lithium-ion secondary battery in which the electrode of the present embodiment is used as a negative electrode. The lithium-ion secondary battery 50 includes a negative electrode 40, a positive electrode 39, and a separator 34 provided between the negative electrode 40 and the positive electrode 39, the separator 34 being composed of a microporous film or the like. The positive electrode 39 includes a positive-electrode current collector 32 and a positive electrode mixture layer 33 which contains a positive-electrode active material. The negative electrode 40 includes a negative-electrode current collector 37 and a negative-electrode active material layer 36 which contains SiOₓ. Via the separator 34, the negative electrode 40 and the positive electrode 39 are disposed so that the negative-electrode active material layer 36 and the positive electrode mixture layer 33 oppose each other. The separator 34 is disposed on the positive electrode 39, and contains an electrolyte solution as necessary. Together with an electrolyte having lithium-ion conductivity, the negative electrode 40, the positive electrode 39, and the separator 34 are accommodated within a case 31 by a sealing plate 35 having a gasket 38. Although not shown, a stainless steel spacer for filling up the space (shortage of intra-case height) in the case 31 is placed inside the case 31. The case 31 is sealed by crimping the sealing plate 35 at the periphery via the gasket 38.

Since the present invention is characterized by the construction of the negative electrode, there are no particular limitations as to the constituent elements of the lithium secondary battery other than the negative electrode. For example, for the positive-electrode active material layer, a lithium-containing transition metal oxide such as lithium cobaltate (LiCoO₂), lithium nickelate (LiNiO₂), or lithium manganate (LiMn₂O₄) can be used, although this is not a limitation. Moreover, the positive-electrode active material layer may be composed of a positive-electrode active material alone, or a mixture containing a positive-electrode active material, a binder agent, and a conductive agent. Similarly to the negative-electrode active material layer, the positive-electrode active material layer may be composed of a plurality of positive-electrode active material members in zigzag shapes. For the positive-electrode current collector, Al, an Al alloy, Ni, Ti, or the like can be used.

As the lithium-ion conductive electrolyte, various solid electrolytes or nonaqueous electrolyte solutions having lithium-ion conductivity may be used. As the nonaqueous electrolyte solution, what is obtained by dissolving a lithium salt in a nonaqueous solvent is preferably used. There is no particular limitation as to the composition of the nonaqueous electrolyte solution.

There is no particular limitation as to the separator and the outer case, and any material that is used for lithium secondary batteries of various forms can be used without particular limitations.

### Example and Comparative Example-1

Hereinafter, Example of an electrode according to the present invention and Comparative Example will be described. Herein, Electrode 1 was produced as Example, and Electrode A was produced as Comparative Example. Moreover, in order to examine the shape controllability of the active material members in each electrode, measurements of the growth angle α of the active material members were taken. Furthermore, each electrode was subjected to a charge-discharge characteristics evaluation.

(i) Method of Producing Electrode

(i-1) Electrode 1

Production of Current Collector

First, a method of producing the current collector which was used in Electrode 1 will be described. A roughening treatment was performed for both faces of a copper foil (HCL-02Z, manufactured by Hitachi Cable, Ltd.) having a thickness of 27 μm by electrolytic plating technique, thus forming copper particles having a particle size of 1 μm. As a result, a roughened copper foil 93 having a surface roughness Rz of 1.5 μm was obtained. Note that surface roughness Rz refers to the ten point-average roughness Rz as defined under the Japanese Industrial Standards (JISB 0601-1994). Alternatively, a roughened copper foil which is commercially-available for use in a printed-circuit board may be used.

Next, a plurality of grooves (dents) were formed on a ceramic roller by using laser engraving. The plurality of grooves had diamond shapes, as seen from the normal direction of the ceramic roller. Each diamond shape had diagonal lengths of 10 μm and 20 μm. Adjoining dents had an interval of 18 μm along their shorter diagonals, and an interval of 20 μm along their longer diagonals. Each dent had a depth of 10 μm. With a line pressure of 1 t/mm, a roll treatment was performed by passing the copper foil between the ceramic roller and another roller which was placed so as to oppose it.

In this manner, a current collector having a plurality of bumps on its surface was obtained. The height of the bumps was about 6 μm.

Formation of Si Vapor-Deposition Layer

FIGS. 10(a) and (b) are schematic cross-sectional views of a vacuum vapor deposition apparatus used in this Example, respectively showing cross sections along planes which are orthogonal to each other.

The current collector 67 obtained with the above method was placed on a stage 63 disposed in the interior of a vacuum chamber 62 of a vacuum vapor deposition apparatus 60 shown in FIG. 10, and an EB vapor deposition was performed by using a vapor deposition unit (i.e., a unit form combining an evaporation source, a crucible 66, and an electron beam generator) and an evaporation source of silicon. At this time, the stage 63 was tilted by 65° with respect to a horizontal plane 69 (ω=65°) so that an angle θbetween the incident direction of vapor-deposition particles and the normal of the current collector 67 was 65° (ω=65°). Moreover, in order to evaporate silicon from the evaporation source, the electron beam generated by the electron beam generator was deflected with a deflection yoke so as to be radiated onto the evaporation source. As the evaporation source, a scrap material (scrap silicon, purity: 99.999%) occurring when forming semiconductor wafers was used. No oxygen gas was introduced into the chamber 62 during vapor deposition.

Oxidation of Vapor-Deposition Layer

The electrode obtained with the above method was subjected to an oxidation treatment at 300° C. for 1 hour the atmosphere. The resultant electrode was designated Electrode 1.

(i-2) Electrode A

With a method similar to the above Example, a current collector was produced. In Comparative Example, as a technique of forming an active material layer, reactive evaporation was employed, where oxygen was introduced into a chamber. By using an apparatus similar to that of Example 1, oxygen gas was introduced into the chamber 62 via a gas introducing tube 65 and an oxygen nozzle 64, and vapor deposition was performed by controlling the oxygen flow rate so that the degree of vacuum was 0.13 Pa. The resultant electrode was designated Electrode A.

(ii) Evaluation

(ii-1) Shape

Regarding the shape of the resultant particles, cross-sectional shape observations were made by using Electrode 1 and Electrode A obtained as Example and Comparative Example.

FIGS. 11(a) and (b) are diagrams showing cross-sectional SEM images of Electrode 1 and Electrode A, respectively. It was found from this that the active material members 18 of Electrode 1 had a growth angle α of 52°, and that the active material members 24 of Electrode A had a growth angle of 30°. Furthermore, it was found that the amount of active material deposited on the dents 13 in Electrode 1 was reduced from that in Electrode A. Moreover, it was confirmed that the vapor deposition step of Electrode 1 exhibits a higher shape controlling ability than does the vapor deposition step of Electrode A, since the active material members 18 of Electrode 1 were thinner than the active material members 24 of Electrode A. This is presumably because oxygen gas was introduced into the chamber when forming the vapor-deposition layer in the vapor deposition step of Electrode A, so that the degree of vacuum in the chamber was lowered and the mean free path of the silicon particles decreased.

(ii-2) Charge-Discharge Characteristics

By using Electrode 1 and Electrode A, sample coin batteries having the construction shown in FIG. 9 were produced, and their charge-discharge characteristics were evaluated.

Each electrode was shaped into a circle with a diameter of 12.5 mm, thus fabricating an electrode for a coin battery. Next, metal lithium which had been punched into a circle with a diameter of 15 mm (thickness: 300 μm) was affixed to a sealing plate. Thereafter, a microporous separator of polyethylene manufactured by Asahi Kasei Corporation, having a thickness of 20 μm, was placed on the metal lithium circle, upon which an electrode for a coin battery was placed. Next, an electrolyte solution of 1.2M LiPF6, adjusted so that ethylene carbonate/ethyl methyl carbonate/diethyl carbonate=3/5/2 (volume ratio), was added dropwise. A stainless steel plate having a thickness of 100 μm was placed for thickness adjustment, and after placing a case thereupon, a crimper was used for sealing. In this manner, Battery 1 and Battery A were obtained.

Each resultant battery was subjected to a charge-discharge test under the following conditions, using a charging and discharging apparatus.

charging: constant-current charging 0.1 mA, end voltage 0V, pause time 30 minutes
discharging: constant-current discharging 0.1 mA, end voltage 1.5V

Thereafter, an irreversible capacity ratio at the first cycle in the aforementioned charge-discharge test was determined by the following equation.

irreversible capacity (%)=100−{(discharge capacity)/(charge capacity)}×100

As a result, the irreversible capacity ratio of Battery 1 was 28%, and the irreversible capacity ratio of Battery A was 34%. The irreversible capacity ratio is correlated with the active material composition, and it was confirmed that the oxygen fraction x was about 0.7 in either electrode.

It was confirmed from the above results that, according to the production method of the present embodiment, controllability of the structure of the active material layer (shape and voidage of active material members) (shape controllability) can be improved over the case where an active material layer having a similar composition is formed via reactive evaporation.

### Example and Comparative Example-2

In this Example, 35 layers of active material members were formed, and their cross-sectional shapes were observed. Moreover, oxygen concentration distributions of the pillar-like members before oxidation and the active material member after oxidation were examined, and the results thereof will be described.

(i) Method of Forming Electrode

(i-1) Electrode 2

By using the vacuum vapor deposition apparatus 60 shown in FIG. 10, an Si vapor-deposition layer was formed on the surface of a current collector similar to that of Electrode 1. In this Example, 50 vapor deposition steps were performed while switching the tilting angle (incident angle) θ of the evaporation direction between 65° and −65° by switching the tilting angle of the stage 63 from the horizontal plane. No oxygen gas was introduced into the chamber 62 during vapor deposition. The pressure inside the chamber during vapor deposition was 8×10⁻³ Pa. As a result, an Si vapor-deposition layer including a plurality of pillar-like members (number of layers: 50 layers) was formed.

Thereafter, by performing a heat treatment at a temperature of 300° C. for 30 minutes in the atmosphere, the Si vapor-deposition layer was oxidized, thus forming an active material layer including a plurality of active material members (number of layers: 50 layers). Thus, Electrode 2 was obtained.

(1-2) Electrode B

On the surface of a current collector similar to that of Electrode 1, an Si vapor-deposition layer was formed by using the vacuum vapor deposition apparatus 60 shown in FIG. 10. Vapor deposition was performed while introducing oxygen gas into the chamber 62. The flow rate of oxygen gas was controlled so that the pressure inside the chamber was 0.13 Pa. Moreover, similarly to Electrode 2, 50 vapor deposition steps were performed while switching the evaporation direction. As a result, an active material layer including a plurality of active material members (number of layers: 50 layers) was formed, thus obtaining Electrode B.

(ii) Evaluation

FIGS. 12(a) and (b) are side views of Electrode 2 and Electrode B, respectively. Thus, it can be seen that the active material members of Electrode 2 are thinner than the active material members of Electrode B. Thus, it was confirmed that the method of producing Electrode 2 exhibits a higher shape controlling ability. Moreover, it was confirmed that the amount of active material deposited on the dents of the current collector was reduced in Electrode 2 as compared to Electrode B. This is presumably because oxygen gas was introduced into the chamber during formation of the vapor-deposition layer of Electrode B, so that the degree of vacuum in the chamber was lowered and the mean free path of the silicon particles decreased.

(iii) Oxygen Concentration Distributions in Pillar-Like Members and Active Material Member

The oxygen distribution inside the pillar-like members before performing the oxidation step of Electrode 2 and the oxygen distribution inside the active material members after the oxidation step of Electrode 2 were confirmed by using an x-ray microanalyzer (EPMA). It was thus found that the oxidation level was enhanced especially in the neighborhood of cracked portions of the active material members. Moreover, not only the surface of the active material members but also the active planes within the active material members had been oxidized. This is presumably because the specific surface of the active material members is very large (10 m²/g, corresponding to 100 nm particles).

Moreover, a sample battery was formed by using Electrode 2, and its irreversible capacity was determined to be 27% with a method similar to that in Example and Comparative Example-1 above. Thus, it was found that an average value of the oxygen ratio x of the active material members is 0.6. On the other hand, a sample battery was formed by using as an electrode the current collector on which pillar-like members before being subjected to an oxidation step were formed, and its irreversible capacity was similarly determined to be 19%. Thus, it was found that an average value of the oxygen ratio x of the pillar-like members is 0.39.

The above results confirm that, according to the present embodiment, it is not that a surface layer with a high oxidation level occurs on the active material members, but that the entire active material members are oxidized through the oxidation step.

### Second Embodiment

Hereinafter, with reference to the drawings, a second embodiment of an electrode according to the present invention will be described. The present embodiment differs from the method of the embodiment described above in that a vapor-deposition layer containing Si is formed on a current collector, and a multiple number of steps of oxidizing this are repeated.

FIGS. 13(a) to (e) are step-by-step cross-sectional views for describing an example of a production method of an electrode according to the present embodiment. For simplicity, constituent elements similar to those in FIG. 1 are denoted by like reference numerals, and the descriptions thereof are omitted.

First, as shown in FIG. 13(a), evaporated particles of source material (which herein are silicon particles) are allowed to strike the surface of the current collector 11 in the direction E. As a result, as shown in FIG. 13(b), a pillar-like portion 14a containing silicon is grown on each bump 12 of the current collector 11. Thereafter, a heat treatment is performed in an oxidation ambient, thus oxidizing the pillar-like portions 14a. Thus, as shown in FIG. 13(c), first portions 18a containing silicon oxide are obtained. Next, as shown in FIG. 13(d), via oblique vapor deposition, Si is further deposited on the first portions 18a to form pillar-like portions 14b. The evaporation direction E may be identical to or different from the evaporation direction E in the vapor deposition step shown in FIG. 13(a). Thereafter, as shown in FIG. 13(e), the pillar-like portions 14b are oxidized. Thus, an active material layer 20 composed of active material members 18 containing silicon oxide is obtained.

Although vapor deposition and oxidation steps are repeated twice in the above method, they may be repeated three or more times. By repeating them a multiple number of times, a thicker active material layer 20 can be formed. The vapor deposition conditions such as the incident angle θ and the heat treatment conditions such as the heating temperature in the present embodiment are similar to the conditions in the above-described embodiment.

In the step of forming an active material layer containing SiOx by oxidizing a vapor-deposition layer containing Si, the thickness of the portion of the vapor-deposition layer that is oxidized is determined based on the rate of diffusion of oxygen within the vapor-deposition layer. Therefore, if voids are scarce in the vapor-deposition layer and the vapor-deposition layer is too thick, the entire vapor-deposition layer may not be oxidized. On the other hand, according to the above method, regardless of the thickness of the active material layer 20, its composition (oxygen ratio x) can be controlled across the entire thickness of the active material layer 20 with greater certainty. The method of the present embodiment is suitably applicable to forming an active material layer (thickness: e.g. 5 μm or more) having a large thickness in particular.

FIGS. 14(a) to (d) are step-by-step cross-sectional views for describing another example of a production method of an electrode according to the present embodiment. For simplicity, constituent elements similar to those in FIG. 1 are denoted by like reference numerals, and the descriptions thereof are omitted.

In this example, first, evaporated particles of source material (which herein are silicon particles) are allowed to strike the surface of the current collector 11 in the direction E. As a result, as shown in FIG. 14(a), a pillar-like portion p1′ containing silicon is grown on each bump 12 of the current collector 11, in a direction G1. Thereafter, by performing a heat treatment in an oxidation ambient, the pillar-like portions p1′ are oxidized. As a result, as shown in FIG. 14(b), first portions p1 containing silicon oxide are obtained. Next, particles of source material are allowed to strike from a direction which is tilted with respect to the normal of the current collector 11 toward the opposite side of the evaporation direction in the vapor deposition step shown in FIG. 14(a). As a result, as shown in FIG. 14(c), a pillar-like portion p2′ containing silicon is grown on each first portion p1 in a direction G2. The direction G2 is tilted with respect to the normal of the current collector 11 toward the opposite side of the growth direction G1 of the first portions. Thereafter, by conducting a heat treatment in an oxidation ambient, the pillar-like portions p2′ are oxidized. As a result, as shown in FIG. 14(d), second portions p2 containing silicon oxide are obtained. Thus, by repeating a multiple number of vapor deposition and oxidation steps by switching the evaporation direction, zigzag-shaped active material members can be formed, as has been described above with reference to FIG. 6, for example.

In the present embodiment, too, if the number of layers becomes large (e.g. 20 layers or more) as in the example shown in FIG. 7, a shape that stands on the surface of the upright current collector 11 may be obtained, instead of a zigzag shape.

### Third Embodiment

Hereinafter, with reference to the drawings, a third embodiment of an electrode according to the present invention will be described. The present embodiment differs from the method of the above-described embodiments in that, in an oxidation step, not only the vapor-deposition layer is oxidized but also an exposed surface of the current collector is oxidized to form a resistor layer.

FIGS. 15(a) and (b) are step-by-step cross-sectional views for describing an example of a production method of an electrode according to the present embodiment. For simplicity, constituent elements similar to those in FIG. 1 are denoted by like reference numerals, and the descriptions thereof are omitted.

First, as shown in FIG. 15(a), a vapor-deposition layer 16 including a plurality of pillar-like members 14 is formed on the surface of a current collector 11 whose main component is a metal such as copper, via oblique vapor deposition. The method of forming the vapor-deposition layer 16 is similar to the method described above with reference to FIGS. 1(a) and (b). At this time, the height H of the bumps of the current collector 11, the interval d between adjoining bumps 12, the incident angle θ, the degree of vacuum in the chamber, and the like are adjusted so that the surface of the current collector 11 is partially exposed between adjoining pillar-like members 14 (see FIG. 3). It suffices if the surface of the current collector 11 is exposed between at least two adjoining pillar-like members 14, and it does not need to be exposed at all intervals between pillar-like members 14.

Next, as shown in FIG. 15(b), a heat treatment is conducted in an oxidation ambient to oxidize the pillar-like members 14, thereby forming an active material layer 20 including the active material members 16. In this heat treatment, the exposed surface of the current collector 11 is also oxidized, whereby a resistor layer 90 having a higher resistivity than that of the material of the current collector 11 is formed. The resistor layer 90 contains an oxide(s) of metal(s) that was contained in the current collector 11 (e.g. copper oxide). The heat treatment conditions such as the temperature and time of the heat treatment and the partial pressure of oxidation gas in the oxidation gas ambient are similar to the conditions in the above-described embodiments. In this manner, the electrode of the present embodiment is obtained.

In addition to effects similar to those of the above-described embodiments, the following advantages are obtained with the above method because the resistor layer 90 is formed on the surface of the current collector 11.

In a conventional electrode (negative electrode), in the case where portions of the surface of the current collector are not covered by the active material but are exposed, portions of the lithium supplied from the positive-electrode active material layer disposed so as to oppose the exposed surface of the current collector may deposit on the exposed surface of the current collector, without being occluded by the active material layer, upon charging. This may become a detrimental factor to the safety of the lithium secondary battery because, if metal lithium deposits on the negative electrode, thermal stability of the negative electrode will be deteriorated. Moreover, if metal lithium deposits as lithium dendrites, it may cause internal short-circuiting between the positive and negative electrodes.

On the other hand, in the present embodiment, since the resistor layer 90 is formed on the exposed surface of the current collector 11, the resistance of lithium deposition reaction on the current collector 11 is increased, so that deposition of lithium is less likely. Moreover, since the resistor layer 90 is formed only in regions of the surface of the current collector 11 that are not in contact with the active material, lithium deposition can be suppressed without increasing the resistance in the charge-discharge reactions. Therefore, while ensuring high rate performance, a battery which provides higher safety than conventionally is obtained. Furthermore, since the resistor layer 90 can be formed through the heat treatment for oxidizing the pillar-like members 14, the above battery can be fabricated without an increase in the number of production steps.

The resistivity of the resistor layer 90 of the present embodiment only needs to be greater than the resistivity of the material of the current collector 11, but is preferably 1 mΩ·cm or more. When the resistivity of the resistor layer 90 is low, the resistance in the lithium deposition reaction is not increased, so that sufficient effect of deposition suppression may not be obtained. On the other hand, when the resistivity is 1 mΩ·cm or more, lithium deposition can be suppressed with greater certainty.

It is preferable that the thickness of the resistor layer 90 is no less than 0.005 μm and no more than 10 μm. When the resistor layer 90 is 10 μm or less, increase in the resistance of the current collector 11 can be suppressed. On the other hand, when the thickness of the resistor layer 90 is 0.005 μm or more, the lithium resistance in the charge-discharge reactions can be increased with greater certainty. More preferably, it is 0.010 μm or more to increase the aforementioned resistance more effectively and suppress lithium deposition. In the case where a copper foil is used as the current collector 11 and a layer of copper oxide obtained by oxidizing the surface of the copper foil is formed as the resistor layer 90, the material of the current collector 11 (copper) has a resistivity of e.g. 1.694×10⁻³ m Ω·cm, and the resistor layer 90 composed of copper oxide has a resistivity of 1×10⁵ to 10⁶ mΩ·cm at the maximum, although varying depending on the oxygen ratio and the temperature of treatment. The thickness of the resistor layer 90 may be adjusted based on the heat treatment conditions such as heating temperature and heating time.

The method of the present embodiment is not limited to the method shown in FIG. 15. FIGS. 16(a) and (b) are schematic step-by-step cross-sectional views showing another example of a production method of an electrode according to the present embodiment. As shown in FIG. 16(a), by conducting a multiple number of vapor deposition steps (oblique vapor deposition) while switching the evaporation direction, a pillar-like member 28′ whose number of layers is 25 is formed on each bump 12 of the current collector 11 containing a metal. In this case, too, the shape and arraying pitch of the bumps 12 of the current collector 11 and the vapor deposition conditions are controlled so that the surface of the current collector 11 is partially exposed between adjoining pillar-like members 28′.

Next, as shown in FIG. 16(b), a heat treatment is performed in an oxidation gas ambient. As a result, the pillar-like members 28′ are oxidized to form the active material members 28, and also the exposed surface of the current collector 11 is oxidized to form the resistor layer 90 containing a metal oxide.

FIGS. 17(a) and (b) are schematic step-by-step cross-sectional views showing still another example of a production method of an electrode according to the present embodiment. As shown in FIG. 17(a), by performing a multiple number of times of oblique vapor deposition while switching the evaporation direction, a pillar-like member 26′ whose number of layers is 5 is formed on each bump 12 of the current collector 11 containing a metal. In this case, too, the shape and arraying pitch of the bumps 12 of the current collector 11 and the vapor deposition conditions are controlled so that the surface of the current collector 11 is partially exposed between adjoining pillar-like members 26′.

Next, as shown in FIG. 17(b), a heat treatment is conducted in an oxidation gas ambient. As a result, the pillar-like members 26′ are oxidized to form the active material members 26, and also the exposed surface of the current collector 11 is oxidized to form the resistor layer 90 containing a metal oxide.

In the methods shown in FIG. 15 to FIG. 17, oblique vapor deposition is used to form the plurality of pillar-like members 14, 28′, and 26′ so that the surface of the current collector 11 is partially exposed. However, the plurality of pillar-like members may be formed by a method different from oblique vapor deposition.

FIG. 18 is a schematic cross-sectional view showing still another electrode according to the present embodiment. In an electrode 203 shown in FIG. 18, an active material layer 112 composed of a plurality of active material members 122 is formed on the surface of the current collector 110 having a ruggedness pattern formed on the surface. The active material members 122 are disposed on the respective bumps (protrusions) of the current collector 110. A resistor layer 114 is formed in regions of the current collector 110 that are not in contact with the active material members 122. With such a construction, spaces 124 are secured for alleviating the stress (expansion stress) caused by the active material member occluding lithium and expanding between active material members 122, so that peeling of the active material layer 112 due to expansion stress can be prevented, and deposition of lithium in portions of the surface of the current collector 110 where the active material was not deposited, including side face portions (protrusion side faces) of the bumps, can be prevented. It also becomes possible to form the resistor layer 114 on the side faces of the bumps.

The electrode 203 is formed as follows. First, bumps having a predetermined shape are formed on the surface of the current collector 110, and a resist layer is formed thereon. Thereafter, the resist layer is subjected to exposure and development, thus forming a resist body having apertures on the bumps. Next, by electroplating technique, pillar-like members containing silicon or tin are formed in the apertures of the resist body. Thereafter, the resist body is removed. With this method, a film including pillar-like members on the respective bumps of the current collector 110 is formed, and also the surface of each dent of the current collector 110 is exposed. A method of forming pillar-like members on the bumps of the current collector 110 and a construction of pillar-like members are disclosed in Japanese Laid-Open Patent Publication No. 2004-127561, for example. Next, the current collector 110 having pillar-like members formed thereon is subjected to a heat treatment in an oxidation gas ambient. The heat treatment conditions are similar to the conditions described in the embodiments described above. In the heat treatment, the pillar-like members are oxidized to become the active material members 122, and also the exposed surface of the current collector 110 is oxidized to form the resistor layer 90 containing a metal oxide (e.g. copper oxide). In this manner, the electrode 203 is obtained, which has the active material layer 112 including the plurality of active material members 122 and the resistor layer 90 formed between adjoining active material members 122.

FIGS. 19(a) and (b) are a perspective view and a cross-sectional view illustrating still another electrode according to the present embodiment. The electrode shown in FIG. 19 includes a plurality of active material members 125 arrayed on the surface of a current collector 110 and a resistor layer 114 formed in portions of the current collector 110 where the active material members 125 are not formed.

The electrode shown in FIG. 19 is formed as follows. First, an active material film is formed on the surface of the current collector 110, and this is patterned. As a result, a plurality of pillar-like members are formed on the surface of the current collector 110, and also portions of the surface of the current collector 110 where the pillar-like members are not formed are exposed. A method of forming pillar-like members by patterning is disclosed in Japanese Laid-Open Patent Publication No. 2004-127561, for example. Next, the current collector 110 having pillar-like members formed thereon is subjected to a heat treatment in an oxidation gas ambient. The heat treatment conditions are similar to the conditions described in the embodiments described above. In the heat treatment, the pillar-like members are oxidized to become the active material members 125, and also the exposed surface of the current collector 110 is oxidized to form the resistor layer 114. In this manner, there is obtained an electrode which has the active material layer 112 including the plurality of active material members 125 and the resistor layer 114 formed between adjoining active material members 125.

The shape and arraying pitch of the bumps 12 of the current collector 11, the thickness of the active material layer, the material for the active material, and the composition of the active material members in the present embodiment are similar to the shape and arraying pitch of the bumps 12, the thickness of the active material layer, the material for the active material, and the composition of the active material members in the above-described first embodiment. Moreover, it is preferable that the current collector of the present embodiment contains copper as a main component, which is preferably a rolled copper foil, a rolled copper alloy foil, an electrolytic copper foil, an electrolytic copper alloy foil, or an electrolytic copper foil which has been subjected to a roughening treatment, a rolled copper foil which has been subjected to a roughening treatment, or the like, for example.

### Example and Comparative Example-3

In this Example, a resistor layer was formed by various methods on a current collector having an active material layer formed thereon by vapor deposition technique, thus producing Electrodes 3 to 6 for evaluation experimentation. For comparison, Electrode C lacking a resistor layer was also produced, and the method thereof will be described. Furthermore, the characteristics of batteries in which Electrodes 3 to 6 and Electrode C were used were evaluated and compared. The evaluation method and the evaluation results will be described.

(i) Production of Electrode

(i-1) Electrodes 3 to 6

Production of Active Material Film

In this Example, a vapor deposition apparatus manufactured by ULVAC, Inc. was used for forming the active material film. FIG. 20 is a schematic cross-sectional view showing the vapor deposition apparatus used in this Example.

The vapor deposition apparatus 600 includes a vacuum container 150 and an evacuation system (not shown) for evacuating the vacuum container 150. In the vacuum container 150, a stage 154 for affixing the current collector 151 is provided, and vertically under the stage 154, a target 155 for depositing an active material on the surface of the current collector 151 is disposed. Moreover, although not shown, an electron beam heating means for heating and evaporating the material of the target 155 is provided. In this Example, as the target 155, elemental silicon (manufactured by Kojundo Chemical Lab. Co., Ltd) with a purity of 99.9999% was used.

First, an electrolytic copper foil (manufactured by Furukawa Circuit Foil Co., Ltd.) having a thickness of 35 μm and a surface roughness Rz of 5 μm was cut into a 40 mm×40 mm size, thereby producing a current collector 51. Note that surface roughness Rz refers to the ten point-average roughness Rz as defined under the Japanese Industrial Standards (JISB 0601-1994).

Next, the current collector 151 was placed on the stage 154 of the vapor deposition apparatus 600, and silicon evaporated from the target 155 was allowed to strike the surface of the current collector 151. The acceleration voltage of the electron beam radiated onto the target 155 was −8 kV, with the emission being set to 500 mA. The elemental silicon vapor from the target 155 was supplied onto the surface of the current collector 151. The tilting angle of the evaporation direction with respect to the normal of the current collector 151 was 0°. As a result, an active material film of silicon was obtained on the surface of the current collector 151. The vapor deposition time was adjusted so that the thickness of the active material film was 10 μm. Thus, four current collectors were produced, each having an active material film formed on their surface.

Formation of Resistor Layer

The four current collectors having an active material film thereon by the above method were each shaped into a circle having a diameter of 12.5 mm. Next, an end portion (width: 2 mm) of the active material film was peeled so as to expose the current collector surface.

Then, in the atmosphere, these current collectors were subjected to an annealing treatment under conditions (annealing temperature, annealing time) as shown in Table 1 below. As a result, in the exposed portions of the current collector, Cu in the neighborhood of the surface of the current collector was oxidized, whereby a resistor layer of copper oxide was formed. At this time, the active material film was also oxidized, whereby an active material layer containing silicon oxide was obtained. Thus, Electrodes 1 to 4 for evaluation experimentation were obtained.

FIGS. 21(a) and (b) are a schematic plan view and a cross-sectional view, respectively, showing the structure of Electrodes 1 to 4 for evaluation experimentation. As shown in the figure, these electrodes have a circular current collector 160 and an active material layer 162 formed thereupon, and a resistor layer 164 is formed on the surface of the current collector 160 exposed through peeling of the active material layer 162.

Next, with respect to samples of annealing times and annealing temperatures as shown in Table 1, the thickness t of the resistor layer 164 of each electrode was observed on an electrode cross section by using an electron microscope (SEM: Scanning Electron microscope). As a result, the thickness t of the resistor layer 164 increased as the annealing temperature increased and as the annealing time increased.

TABLE 1

| | annealing | |
|---|---|---|
| samples | temperature | annealing time |
| Electrode 3 | 100° C. | 1 hour |
| Electrode 4 | 200° C. | 1 hour |
| Electrode 5 | 300° C. | 1 hour |
| Electrode 6 | 300° C. | 10 minutes |

(i-2) Electrode C

With a method similar to (i-1) above, an active material film was formed on a current collector, and an end portion (width: 2 mm) of the active material film was peeled so as to expose the current collector. No annealing treatment was performed. In this manner, Electrode C lacking a resistor layer was obtained.

(ii) Production of Test Batteries No. 3 to No. 6 and Test battery C

By using Electrodes 3 to 6 for evaluation experimentation and Electrode C, coin-type test battery No. 3 to No. 6 and test battery C were produced, in which lithium metal was used as a counter electrode. In these batteries, each of the above electrodes serves as a positive electrode, and metal lithium serves as a negative electrode. However, similar results will be obtained also by producing batteries in which each of the above electrodes is a negative electrode and subjecting them to a charge-discharge test.

First, a metal lithium foil (manufactured by Honjo Chemical Corporation) having a thickness of 300 μm was shaped into a circle with a diameter of 17 mm, and press-fitted in a coin battery sealing plate, thus to become a counter electrode (which herein was the negative electrode). Via a separator, Electrode 3 was placed upon this. Herein, a polyethylene porous film (manufactured by Asahi Kasei Chemicals Corporation) having a thickness of 20 μm was used as the separator.

Moreover, ethylene carbonate (EC) and dimethyl carbonate (DMC) were mixed at a volume ratio of 1:1, and a nonaqueous electrolyte solution obtained by dissolving LiPF₆ at a concentration of 1.0 mol/L therein was used to impregnate the negative electrode and the separator. Thereafter, current collector plate having a thickness of 100 μm and an outer case (made of SUS) were placed, and were sealed by crimping. In this manner, coin-type test battery No. 3 was obtained.

Similarly, coin batteries were produced by using Electrodes 4 to 6 and Electrode C, and were respectively designated test battery No. 3 to No. 6 and test battery C.

(iii) Evaluation Method and Results of Test Batteries

First, each test battery was subjected to a charge test under the following conditions.

current value: 0.1 mA

end voltage: −20 mV (potential against Li counter electrode)

After the charge test, each test battery was disassembled and the electrodes were taken out. The electrodes taken out were cleaned by using dimethyl carbonate and then dried, and their surface was observed.

As a result, lithium deposition was not observed in Electrodes 3 to 6 used in test batteries No. 3 to No. 6 were used. On the other hand, in Electrode C used in test battery C, deposition of lithium metal was observed in the exposed portions (i.e., portions not in contact with the active material) of the current collector. It was thus confirmed that, by providing a resistor layer, deposition of lithium metal at the exposed portions of the current collector can be suppressed.

Note that, in Example and Comparative Example-3, a portion of the active material layer was intentionally peeled to form a resistor layer, in order to evaluate the effect of the resistor layer. Similar effects will also be obtained by, in the vapor deposition step, allowing the plurality of pillar-like members to grow at an interval so that portions of the surface of the current collector are left exposed and a resistor layer is formed on the exposed surface of the current collector (see FIG. 15 to FIG. 17). Furthermore, similar effects will also be obtained by forming a resistor layer on the current collector surface that is not in contact with the active material in the case where pinholes are formed in the active material layer at the formation of the active material layer, or where an active material layer formed by coating technique has swollen to cause voids between itself and the current collector, and so on.

### Reference Embodiment

In the aforementioned lithium-ion secondary battery, when in an overcharged state due to use with an unexpected method or environment, metal lithium may deposit on the negative electrode. This may become a detrimental factor to the safety of the lithium secondary battery. The reason is that, when metal lithium deposits on the negative electrode, the thermal stability of the negative electrode is degraded. Moreover, when metal lithium deposits as lithium dendrites, it may cause internal short-circuiting between the positive and negative electrodes.

The reason why lithium deposits on the negative electrode may be considered as follows. When forming a negative-electrode active material layer on a negative-electrode current collector, pinholes may occur in the negative-electrode active material layer so that the surface of the negative-electrode current collector is not completely covered, or the negative-electrode active material layer may partially peel from the surface of the negative-electrode current collector. Thus, when any portion that is not covered by the negative-electrode active material layer (referred to as “exposed portion of the current collector”) occurs on the surface of the negative-electrode current collector, a part of the lithium which is supplied from the positive-electrode active material layer disposed so as to oppose the surface of the negative-electrode current collector may deposit in the exposed portion of the negative-electrode current collector at the time of charging, without being occluded by the negative-electrode active material layer.

Against this, materials for the active material intended for suppressing lithium deposition are proposed (e.g., Japanese Laid-Open Patent Publication No. 11-297311, Japanese Laid-Open Patent Publication No. 9-293536). However, there is a possibility that the range of materials for the negative-electrode active material to choose from may be narrowed, thus making it difficult to attain a higher capacity.

On the other hand, the specification of Japanese Patent No. 3754374 proposes, in a negative electrode having an active material layer containing at least one of silicon and tin on a current collector, providing an oxide film between the current collector and the active material layer, with a purpose of appropriately controlling reaction and diffusion at the interface between the active material layer and the current collector. Moreover, Japanese Laid-Open Patent Publication No. 2005-78963 proposes forming a dissolution prevention film on the surface of the negative-electrode current collector and forming an active material layer on the dissolution prevention film, in order to suppress dissolution of the negative-electrode current collector of Cu due to over-discharging. Use of a metal oxide film, a film of fluorine-type resin, and the like as the dissolution prevention film is illustrated as an example. These patent documents propose forming an oxide film or a dissolution prevention film on a current collector and thereafter forming an active material layer thereupon, with purposes that are different from suppression of lithium deposition. According to a study by the inventors, in a negative electrode proposed in these patent documents, the entire current collector surface is covered by a film (hereinafter referred to as a “high-resistance film”) having a higher resistance than that of the material of the current collector (e.g. Cu), so that a lithium deposition reaction is less likely to occur. Presumably as a result of this, lithium deposition due to pinholes and peeling of the active material member layer is suppressed.

In the construction proposed in the specification of Japanese Patent No. 3754374, the oxide film as a high-resistance film needs to cover the entire current collector surface in order to attain its purpose. Similarly, in the construction proposed in Japanese Laid-Open Patent Publication No. 2005-78963, the dissolution prevention film as a high-resistance film needs to be formed so as to cover the entire current collector surface. Based on these constructions, since the high-resistance film exists between the current collector surface and the active material layer, there is a possibility that the resistance in the charge-discharge reactions may increase. When the resistance in the charge-discharge reactions increases, the charge-discharge characteristics of the high-rate may be deteriorated.

A negative electrode for a lithium-ion secondary battery according to the present embodiment includes: a current collector; an active material layer formed in contact with the surface of the current collector, the active material layer being composed of a substance which occludes and releases lithium; and a resistor layer formed in a region of the surface of the current collector that is not in contact with the active material, the resistor layer having a higher resistivity than that of the material of the current collector.

In accordance with the negative electrode for a lithium-ion secondary battery of the present embodiment, in a region of the surface of the current collector that is not in contact with the active material, a resistor layer having a higher resistivity than that of the material of the current collector is formed, whereby deposition of lithium on the surface of the current collector can be suppressed. Moreover, since the resistor layer is formed in a region which is not in contact with the active material, the aforementioned effect of suppressing lithium deposition can be obtained without increasing the resistance in the charge-discharge reactions, as compared to constructions (Patent Documents 4 and 5) in which a film having a high resistance is formed as an underlayer on the current collector surface. Therefore, the safety of the lithium-ion secondary battery can be enhanced without deteriorating its rate performance. Furthermore, the present invention is advantageous because lithium deposition can be suppressed irrespectively of the material, construction, formation method, etc., of the active material layer.

Therefore, according to the present embodiment, a lithium-ion secondary battery can be realized which has a high capacity, a high output power, a long life, and high rate performance, and yet higher safety than conventionally. Moreover, according to the production method of the present embodiment, without complicating the production steps, a negative electrode for a lithium secondary battery can be produced by a simple method which provides excellent producibility.

Hereinafter, with reference to the drawings, a negative electrode for a lithium-ion secondary battery according to the present embodiment will be described. FIGS. 22(a) and (b) are schematic cross-sectional views showing a portion of a negative electrode for a lithium-ion secondary battery according to the present embodiment (hereinafter also referred to as a “negative electrode”).

First, FIG. 22 is referred to. The negative electrode 200 includes a current collector 110 and an active material layer 112 formed on the surface of the current collector 110, the material layer 112 being composed of an active material which occludes and releases lithium. The active material layer 112 is formed in contact with the surface of the current collector 110, and in regions 112a of the surface of the current collector 110 that are not in contact with the active material, a resistor layer 114 having a higher resistivity than that of the material of the current collector 110 is formed.

In the negative electrode 100, the active material layer 112 has apertures 116 extending from the upper face of the active material layer 112 and reaching the surface of the current collector 110, such that the resistor layer 114 is formed in regions of the surface of the current collector 110 that are exposed through the apertures 116 (i.e., regions which are not in contact with the active material) 112a. The apertures 116 of the active material layer 112 may be pinholes which occurred during formation of the active material layer 112, or peeled portions which, after the formation of the active material layer 112, resulted from peeling of portions thereof. Such a peeled portion may be a recessed portion resulting from peeling of an end portion of the active material layer 112. Alternatively, it may have been intentionally formed in the active material layer 112 with a purpose of alleviating expansion stress in the active material layer 112 or any other purpose, for example.

The resistor layer 114 may be a metal oxide layer, a layer of organic substance, or the like. Among others, it is preferably a metal oxide layer, from standpoints of thermal resistance, potential stability in charge-discharge reactions, and so on.

There is no particular limitation as to the method of forming the resistor layer 114. For example, the resistor layer 114 may be an oxide layer which is formed by oxidizing exposed portions of the current collector 110 after forming the active material layer 112. This is advantageous because not only is the resistor layer 114 easily formed, but also adhesion between the current collector 110 and the resistor layer 114 can be ensured with greater certainty. Alternatively, as in a negative electrode 201 shown in FIG. 22(b), after the active material layer 112 is formed, an organic substance which reacts with the material of the current collector 110 may be added to form a resistor layer 114 composed of the organic substance.

In the negative electrodes 200 and 201 according to the present embodiment, the resistor layer 114 is formed in the regions 112a of the surface of the current collector 110 that are not in contact with the active material, so that deposition of lithium on such regions 112a can be suppressed.

As mentioned earlier, the constructions proposed in the specification of Japanese Patent No. 3754374 and Japanese Laid-Open Patent Publication No. 2005-78963 have a problem in that a high-resistance film exists between the current collector surface and the active material layer, thus increasing the resistance in the charge-discharge reactions. On the other hand, in the present embodiment, the resistor layer 114 is only formed in regions of the surface of the current collector 110 that are not in contact with the active material, so that the aforementioned effect of suppressing lithium deposition can be obtained without increasing the resistance in the charge-discharge reactions. Therefore, it is possible to enhance the safety of the lithium-ion secondary battery without deteriorating its rate performance.

Moreover, in the present embodiment, the material for the active material is not limited for the purpose of suppressing lithium deposition. As a result, the material for the active material layer 112 can be selected with a high degree of freedom, thus permitting a further increase in capacity.

The active material layer 112 of the present embodiment can be formed by using a vacuum process such as sputter technique or vapor deposition technique. Using a vacuum process is preferable because good adhesion between the active material layer 112 and the current collector 110 can be ensured.

Instead of a vacuum process, the active material layer may be formed by using a coating technique to coat the surface of a current collector with a paste obtained by mixing a powder material for the active material with a binder agent and a solvent. It was found through a study of the inventors that, when an active material layer is formed by coating, lithium may deposit not only on the current collector surface that is exposed through pinholes or the like in the active material layer (coating film), but also on the current collector surface under any portion (swollen portion) that has been lifted off the current collector surface due to swelling of a portion of the active material layer. Therefore, even in the case where there are no apertures such as pinholes in the active material layer, if a swollen portion has occurred in the active material layer, it is preferable to form a resistor layer on the current collector surface existing under it.

FIG. 23 is a schematic cross-sectional view illustrating another negative electrode for a lithium secondary battery according to the present embodiment, which includes an active material layer formed by using the aforementioned coating technique. In a negative electrode 202 shown in FIG. 23, the active material layer 112, which is a coating film, is partially lifted off the surface of the current collector 110, so that a swollen portion 120 having a void 118 is created between the active material layer 112 and the current collector 110. In a region 112a of the surface of the current collector 110 that exists under the swollen portion 120 and is not in contact with the active material, a resistor layer 114 is formed. Thus, even in the case where the active material layer 112 formed by using coating technique is partially lifted off the current collector 110, deposition of lithium on the surface of the current collector 110 can be prevented by providing the resistor layer 114. Note that the resistor layer 114 shown in FIG. 23 can be formed by, after formation of the active material layer 112, subjecting the current collector 110 to a heat treatment to oxidize the surface portion of the region 112a, for example.

The active material layer 112 of the present embodiment may include active material members which are selectively formed only on the bumps of a current collector having ruggednesses on its surface. Alternatively, it may be composed of a plurality of pillar-like active material members obtained by patterning an active material film which is formed on the current collector 110. Moreover, the active material layer 112 may be a porous film. In the case where Sn is used as the active material, the active material layer 112 can also be formed by plating technique. Furthermore, formation of the resistor layer 114 may be conducted prior to formation of the active material layer 112.

In the present embodiment, it is preferable that at least a portion of the surface of the resistor layer 114 is not in contact with the active material layer 112 because, when the active material layer 112 is formed in contact with the surface of the resistor layer 114, the resistance in the charge-discharge reactions may increase, thereby deteriorating the charge-discharge characteristics. It is particularly advantageous if the entire surface of the resistor layer 114 lacks contact with the active material. Moreover, the range of preferable thickness of the resistor layer 114 is similar to the range described in the above embodiments.

When there is a fear that the resistor layer may become thick and deteriorate the high-rate performance, it is preferable that the resistor layer 114 of the present embodiment is formed only in the regions 112a of the surface of the current collector 110 that are not in contact with the active material, and is not formed upon the surface of the active material layer 112. As a result, the lithium deposition reaction can be suppressed while ensuring high-rate performance.

As the material of the active material layer 112 of the present embodiment, known materials which reversibly occlude and release lithium can be used without particular limitations. Examples thereof include graphite materials such as natural graphites and artificial graphites, which are conventionally employed in non-aqueous electrolyte secondary batteries, amorphous carbon materials, and compounds and oxides of Al, Sn, Si, etc., that are known to form alloys with Li, and so on.

More preferably, active materials such as Si and Sn, which form alloys with Li, are used. Use of these active materials makes it possible to achieve a high capacity. Still more preferably, the active material layer 112 contains an oxide of Si or an oxide of Sn. As a result, a high capacity and excellent cycle characteristics can be reconciled.

There is no particular limitation as to the material composing the current collector 110, which may be copper, titanium, nickel, stainless steel, or the like; however, from the standpoint of achieving a high capacity and stability with respect to potential, it is preferably copper or an alloy containing copper. As the current collector 110, an electrolytic copper foil, an electrolytic copper alloy foil, an electrolytic copper foil which has been subjected to a roughening treatment, a rolled copper foil which has been subjected to a roughening treatment, or the like can be used, for example.

It is preferable that ruggednesses are formed on the surface of the current collector 110. The reason is that, when ruggednesses are formed on the surface of the current collector 110, the area of contact between the surface of the current collector 110 and the active material is increased, whereby an enhanced adhesion with the active material layer 112 is obtained. Moreover, the current collector 110 may have a regular ruggedness pattern.

Next, with reference to the drawings, an exemplary construction of a lithium-ion secondary battery which is obtained by applying the negative electrode of the present embodiment will be described.

FIG. 24 is a schematic cross-sectional view illustrating a coin-type lithium-ion secondary battery in which a negative electrode of the present embodiment is used. FIG. 25 is a schematic enlarged cross-sectional view showing an electrode group in the battery shown in FIG. 24.

As shown in FIG. 24, a lithium-ion secondary battery 300 has an electrode group including a positive electrode 140, a negative electrode 200, and a separator 144 provided between the negative electrode 200 and the positive electrode 140, and an outer case 145 accommodating the electrode group. The positive electrode 140 includes a positive-electrode current collector 130, and a positive-electrode active material layer 132 formed on the positive-electrode current collector 130. The negative electrode 200 has the construction described above with reference to FIG. 22(a). The positive-electrode current collector 130 and the current collector (negative-electrode current collector) 110 are connected to one end of the positive electrode lead 146 and one end of the negative electrode lead 147, respectively, whereas the other ends of the positive electrode lead 146 and the negative electrode lead 147 are taken out of the outer case 145. The separator 144 is impregnated with an electrolyte having lithium-ion conductivity. The negative electrode 200, the positive electrode 140, and the separator 144 are accommodated within the outer case 145 together with the electrolyte having lithium-ion conductivity, and are sealed with a resin material 148.

Next, the construction of the electrode group of the lithium-ion secondary battery 300 will be described in more detail. As shown in FIG. 25, the negative electrode 200 and the positive electrode 140 are disposed so that the active material layer (negative-electrode active material layer) 112 of the negative electrode 200 and the positive-electrode active material layer 132 oppose each other via the separator 144. The resistor layer 114 is formed in a region (active-material-undeposited portion) of the surface of the negative-electrode current collector 110 on the positive electrode 140 side that is located in a portion opposing the positive electrode 140 (positive-negative electrodes opposing portion) P and has no active material deposited thereon. As used herein, an “active-material-undeposited portion” includes, in addition to any portion where the active material was not deposited (active material-unformed portion), an active-material-removed portion, which is obtained by forming an active material film and thereafter removing a portion thereof, and an active-material-peeled portion, which occurs due to peeling of a portion of the active material film. Although it is preferable that the active-material-undeposited portion is entirely covered with the resistor layer 114, a lithium deposition preventing effect can be obtained so long as at least a portion of the active-material-undeposited portion is covered by the resistor layer 114. Note that, since lithium is unlikely to deposit in any region of the surface of the negative-electrode current collector 110 other than the positive-negative electrodes opposing portion P, the surface of the negative-electrode current collector 110 may be exposed.

In a conventional lithium-ion secondary battery, if an active-material-undeposited portion exists on the current collector surface in a portion where the negative electrode and the positive electrode oppose each other, there is a possibility that lithium may deposit in the active-material-undeposited portion of the current collector during a battery charging reaction. If lithium deposits, it may become a factor causing deterioration of thermal stability and internal short-circuiting between the positive and negative electrodes. On the other hand, in accordance with the lithium-ion secondary battery 300 of the present embodiment, a resistor layer is formed on the active-material-undeposited portion of the current collector surface, thereby increasing the resistance of lithium deposition reaction on the current collector. Thus, lithium deposition is unlikely to occur, and an improved safety can be obtained.

Although the lithium-ion secondary battery 300 of the present embodiment includes the negative electrode 200 shown in FIG. 22, it may include the negative electrode 202 described with reference to FIG. 23 instead, whereby similar effects will be obtained.

Although FIG. 24 and FIG. 25 show an example of a stacked-type lithium-ion secondary battery, the negative electrode for a lithium secondary battery according to the present embodiment is also applicable to a cylindrical battery, a prismatic-type battery, and the like having a spiral-type (wound-type) electrode group. In a stacked-type battery, positive electrodes and negative electrodes may be stacked in three or more layers. However, a positive electrode having a positive-electrode active material layer on both faces or one face and a negative electrode having a negative-electrode active material layer on both faces or one face are used, so that the entire positive-electrode active material layer opposes the negative-electrode active material layer and that the entire negative-electrode active material layer opposes the positive-electrode active material layer. In the case where a negative electrode having active material layers on both faces of the current collector is used, it is preferable, on either surface of the current collector, to provide a resistor layer in any portion that is not in contact with the active material.

Next, the present embodiment will be specifically described based on an Example. However, the following Example does not limit the present embodiment.

### Example and Comparative Example-4

In this Example, a resistor layer was formed on a current collector having an active material layer formed thereof by coating technique, thus producing Electrode 7. For comparison, Electrode D lacking a resistor layer was also produced. Furthermore, the characteristics of batteries in which Example Electrode 7 and Electrode D were used were evaluated and compared. The method of producing the electrodes and batteries, and the evaluation method and results of the batteries will be described.

(i) Production of Electrode

(i-1) Electrode 7

First, a paste containing an active material was produced. In this Example, the paste was obtained by adding water as a solvent to 100 parts by weight of a flake graphite (active material) as the active material capable of occluding and releasing lithium, 1 part by weight (on a solid content basis) of a water-soluble dispersion of SBR as the binder agent, and 1 part by weight of carboxymethyl cellulose as a thickener, and kneading it to cause dispersion.

Next, using a copper foil having a thickness of 10 μm as a current collector, the aforementioned paste was applied onto the current collector. Then, after drying it for 30 minutes at a temperature of 110° C., a rolling was performed, whereby an active material layer was obtained. The resultant active material layer had a thickness of 70 g m.

Thereafter, the current collector having the active material layer formed thereon was shaped into a circle having a diameter of 12.5 mm, and similarly to Example 1, an end portion (width: 2 mm) of the active material layer was peeled to expose the current collector surface.

Next, in the atmosphere, an annealing treatment at a temperature of 200° C. was performed for 1 hour to oxidize the exposed portion of the current collector, thereby forming a resistor layer composed of copper oxide. In this manner, Electrode 7 for evaluation experimentation was obtained. The construction of Electrode 7 is similar to the construction described with reference to FIGS. 21(a) and (b).

(i-2) Electrode D

With a method similar to that of Electrode 7, an active material layer was formed on a current collector by coating technique, and an end portion (width: 2 mm) of the active material layer was peeled to expose the current collector surface. No annealing treatment was performed. In this manner, Electrode D lacking a resistor layer was obtained.

(ii) Production of Test Battery No. 7 and Test Battery D

By using Electrode 7 and Electrode D above, coin batteries were produced by a method similar to the method of producing test batteries in Example and Comparative Example-3 above, which were respectively designated test battery No. 7 and test battery D.

(iii) Evaluation Method and Results of Test Batteries

Test battery No. 7 and test battery D were subjected to a charge-discharge test by a method similar to the evaluation method in Example and Comparative Example-3 above, thus confirming whether lithium deposition had occurred or not.

As a result, no lithium deposition was confirmed in Electrode 7 used for test battery No. 7, whereas lithium had deposited in Electrode D of test battery D. Thus it has been found that, by forming a resistor layer on the exposed surface of the current collector, it is possible to suppress deposition of lithium metal on the surface of the current collector and suppress short-circuiting between positive and negative electrodes and deteriorations in thermal stability due to lithium deposition.

### INDUSTRIAL APPLICABILITY

The present invention is applicable to lithium secondary batteries of various forms, but will be particularly useful for a lithium secondary battery which is required to have a high capacity and good cycle characteristics. There is no particular limitation to the shape of the lithium secondary battery to which the present invention is applicable, and any shape may be used, e.g., coin-type, button-type, sheet-type, cylindrical-type, flat-type, or prismatic-type. The configuration of the electrode group, which consists of a positive electrode, a negative electrode, and a separator, may be a wound type or a stacked type. The battery size may be small, as used for small-sized portable devices or the like, or large, as used for electric vehicles or the like.

A lithium secondary battery according to the present invention can be used as a power supply of a mobile information terminal such as a PC, a mobile phone, or a PDA, a portable electronic device, an audio-visual device such as a videorecorder or a memory audio player, a small power storage device for households, a motorcycle, an electric vehicle, or a hybrid electric vehicle, for example. However, there is no particular limitation as to usage.

1. A production method of an electrode for a lithium-ion secondary battery, comprising:
(A) a step of providing a current collector having a plurality of bumps on a surface thereof;
(B) a step of allowing an evaporated source material to strike from a direction which is tilted with respect to a normal of the surface of the current collector to form a corresponding plurality of pillar-like members on the plurality of bumps; and
(C) a step of oxidizing the plurality of pillar-like members to form a plurality of active material members containing an oxide of the source material.

2. The production method of an electrode for a lithium-ion secondary battery of claim 1, wherein step (C) comprises a step of subjecting the current collector having the plurality of pillar-like members formed thereon to a heat treatment in an oxidation ambient.

3. The production method of an electrode for a lithium-ion secondary battery of claim 2, wherein,
the current collector contains a metal as a main component;
step (B) is a step of depositing the evaporated source material on the surface of the current collector so that the surface of the current collector is partially exposed between adjoining pillar-like members among the plurality of pillar-like members; and
step (C) comprises a step of oxidizing the exposed surface of the current collector to form a resistor layer having a higher resistivity than that of a material of the current collector.

4. The production method of an electrode for a lithium-ion secondary battery of claim 1, wherein step (B) is performed in a chamber having a pressure of 0.1 Pa or less.

5. The production method of an electrode for a lithium-ion secondary battery of claim 1, wherein the source material contains silicon, and the active material members contain silicon oxide.

6. The production method of an electrode for a lithium-ion secondary battery of claim 5, wherein an average value of a molar ratio x of an oxygen amount relative to a silicon amount of the active material members is greater than 0.5 and less than 1.5.

7. The production method of an electrode for a lithium-ion secondary battery of claim 3, wherein the current collector contains copper, and the resistor layer is composed of an oxide containing copper.

8. The production method of an electrode for a lithium-ion secondary battery of claim 2, wherein a temperature of the heat treatment is no less than 100° C. and no more than 600° C.

9. A production method of an electrode for a lithium-ion secondary battery, comprising:
(a) a step of forming a plurality of pillar-like members at intervals on a surface of a current collector containing a metal as a main component, and partially exposing the surface of the current collector at the intervals between the plurality of pillar-like members; and
(b) a step of subjecting the current collector having the plurality of pillar-like members formed thereon to a heat treatment in an oxidation ambient to oxidize the plurality of pillar-like members and form a plurality of active material members, and oxidizing the exposed surface of the current collector to form a resistor layer having a higher resistivity than that of a material of the current collector.

10. A production method of an electrode for a lithium-ion secondary battery, comprising:
(A) a step of providing a current collector having a plurality of bumps on a surface thereof;
(a1) a step of allowing an evaporated source material to strike from a direction which is tilted with respect to a normal of the surface of the current collector to form a first pillar-like portion on each bump;
(a2) a step of oxidizing the first pillar-like portion to form a first portion containing an oxide of the source material;
(b1) a step of allowing an evaporated source material to strike from a direction which is tilted with respect to the normal of the surface of the current collector to form a second pillar-like portion on the first portion; and
(b2) a step of oxidizing the second pillar-like portion to form a second portion containing an oxide of the source material,
thereby forming an active material member on each bump, the active material member including the first and second portions.

11. An electrode for a lithium secondary battery which is produced by the method of claim 1.

12. A electrode for a lithium-ion secondary battery, comprising:
a current collector having a plurality of bumps on a surface thereof;
a plurality of active material members supported at intervals on the plurality of bumps; and
a resistor layer disposed between adjoining active material members among the plurality of active material members, the resistor layer having a higher resistivity than that of a material of the current collector, wherein,
the current collector contains a metal as a main component, and the resistor layer contains an oxide of the metal.
